(19) United States
(12) Patent Application Publication
(10) Pub. No.: US 2025/0121906 A1
(43) Pub. Date: Apr. 17, 2025

(54) Foot-Operated Peripheral Device

(71) Applicant: GLYDR GALACTIC HOLDINGS INC., Plano, TX (US)

(72) Inventors: Richard J. TETT, Plano, TX (US); Braydon Clark Schramm, Italy, TX (US)

(21) Appl. No.: 19/000,017

(22) Filed: Dec. 23, 2024

Related U.S. Application Data
(63) Continuation-in-part of application No. 18/790,571, filed on Jul. 31, 2024.
Application No. 18/790,571 is a continuation of application No. 17/348,190, filed on Jun. 15, 2021, now abandoned.
Application No. 17/348,190 is a continuation of application No. 16/368,342, filed on Mar. 28, 2019, now Pat. No. 11,036,283.
Application No. 16/368,342 is a continuation-in-part of application No. 15/874,701, filed on Jan. 18, 2018, now Pat. No. 10,275,019.
(60) Provisional application No. 63/074,830, filed on Sep. 4, 2020.

(51) Int. Cl. B62K 11/00; B62D 51/02; B62J 45/40

(52) U.S. Cl. CPC B62K 11/007; B62D 51/02; B62J 45/40; B62K 2204/00

(57) ABSTRACT

A device with rotatable footpads for use with interactivity systems and method for same are disclosed. The apparatus may comprise two footpads that rotate independently with respect to at least one axis; two sole flaps that rotate independently and each are associated with a respective footpad; a plurality of sensors that detect the position of each footpad and each sole flap; and a controller transmitting signals from the plurality of sensors representing the movement of each footpad or sole flap to a virtual reality or teleoperation system. The method for using the apparatus may comprise stabilizing footpads by a mechanical means, detecting a movement of the footpads or the sole flaps via sensors; and transmitting a digital representation of the rotation of the footpads to an interactivity system.

### BACKGROUND OF INVENTION

### 1. Cross-Reference to Related Application

This application is a continuation-in-part of pending U.S. patent application Ser. No. 18/790,571 filed on Jul. 31, 2024. U.S. patent application Ser. No. 18/790,571 is a continuation of pending U.S. patent application Ser. No. 17/348,190 filed on Jun. 15, 2021. U.S. patent application Ser. No. 17/348,190 is a continuation-in-part of U.S. patent application Ser. No. 16/368,342 filed on Mar. 28, 2019, now U.S. Pat. No. 11,036,283 issued on Jun. 15, 2021. U.S. patent application Ser. No. 17/348,190 also claims priority benefit of U.S. provisional application Ser. No. 63/074,830 filed on Sep. 4, 2020. U.S. patent application Ser. No. 16/368,342 is a continuation-in-part application of U.S. patent application Ser. No. 15/874,701 filed on Jan. 18, 2018, now U.S. Pat. No. 10,275,019 issued on Apr. 30, 2019. The technical disclosures of every application and publication listed in this paragraph are hereby incorporated herein by reference.

### 2. Field of Invention

The present invention relates to display systems, specifically, controllers for interacting with display, entertainment, and/or control systems.

### 3. Description of Related Art Including Information Disclosed Under 37 C.F.R. 1.97 and 1.98

Virtual reality systems have recently become more and more predominant as visual displays, whether in use with video or electronic games, or with other types of visual media. Today, interactive virtual reality systems are becoming a household item, especially with the growth of uses for virtual reality systems. Virtual reality systems can be used not only for video or electronic games, but they can be used for research, educational, communication, and business purposes.

However, problems persist in the area of virtual reality systems. Because virtual reality systems are meant to visually simulate an environment, users of virtual reality systems have limited ways of interacting with these systems. For example, virtual reality users use headsets that generate realistic images and sounds to simulate the users' physical presence in a virtual or imaginary environment. However, in these environments, users want to interact with the virtual or imaginary environment and will physically move to interact with the virtual or imaginary environment. Often, users who move according to a virtual or imaginary environment will encounter an obstacle in real life, which not only limit the experience by the interruption of movement, but can result in injury to the user or damage to walls, furniture, equipment, or other items. The need for alternative solutions for directing movements or locomotion in virtual reality is well publicized.

There are several devices that simulate travel or locomotion in a virtual reality system while the users are stationary. One of which are foot-controlled devices. One representative of this is a product known commonly as the “3dRudder.” This product is disclosed in U.S. Pat. Application No. US20170185168 by Bonora, et al and European Pat. Application EP20150798185 (WO 2016042407 A1) by Bonora, et al. While a contribution to the field, the 3dRudder and like devices are disadvantageous in that they require the user to be seated and use their legs and feet together in an unnatural way—especially in the control of rotation—which may lead to back pain and exhaustion. Furthermore, the sense of motion is conveyed only by visual changes in the Virtual Reality and no perception of travel or rotation is conveyed through the feet, legs, body or skin. Although the 3dRudder is capable of moving in several directions, it can only indicate travel in a series of linear vectors, similar to a joystick. It is not possible to travel in an arc, rotate in place, or travel backward in an arc. Inconsistent motion cues between sight and body contributes to disorientation and sickness while navigating a Virtual Reality environment. Additionally, the 3D Rudder does not allow for a user's feet to move independently of one another to trigger a rotation. This product provides movement in a single plane, but offers no capability or option to control vertical ascent/descent.

Another foot-controlled device is disclosed in U.S. Pat. Application No. US2017/0160793 by Perlin, et al. This invention comprises a mat comprising pressure sensitive tiles upon which a user stands and manipulates the distribution of weight to various parts of each foot. The pressure distribution “image” is analyzed and movements forward, backward and sideways may be indicated. Although a user can be trained to use the mat to effect motion in a Virtual Reality system, it is disadvantageous as a virtual vehicle for locomotion for several reasons. Firstly, it is a homogenous surface with no physical attributes typical of a mechanism by which a foot controls acceleration or direction. Secondly, there is no feedback to the feet other than the pushback of the surface, so the user is left to imagine that their feet are moving control surfaces typical of a vehicle. It is well-known that when a person perceives movement through his eyes without any other sensations of movement, they may experience virtual reality sickness with symptoms including headache, disorientation, nausea, etc. Many available devices for VR locomotion, including this one, do not provide active feedback of movement to remediate this problem. Thirdly, the logic by which the mat depressions are interpreted must be calibrated for users based on their weight and foot size.

Other types of currently available devices are disclosed in U.S. Pat. No. 9,522,324 B2 by Levasseur, et al; U.S. Pat. No. 5,864,333 by O′Heir; U.S. Pat. No. 4,817,950 by Goo; U.S. Pat. Application No. US20080261696 by Yamazaki, et al.; U.S. Pat. No. 5,860,861 by Lipps, et al.; U.S. Pat. No. 5,872,438 by Roston; U.S. Pat. Application No. US20130344926 by Claudel, et al.; U.S. patent application No. 20090058855 by Mishra, et al.; U.S. patent application No. 20090111670 by Williams; U.S. Pat. No. 8,979,722 by Klein, et al.; U.S. Pat. No. 8,398,100 by Tedla; and U.S. patent application No. 20110306425 by Rivard, et al.

What is needed is a device that simulates locomotion in a virtual reality system while the user does not physically travel or encounter barriers or does not require restraints (as do omnidirectional treadmills), that rotates in place, and that makes the user feel like he is moving.

The need for a foot-operated locomotion and control device extends to non-immersive virtual reality systems such as video or electronic games.

There also exists a need for additional user inputs for foot-operated locomotion and control systems.

### BRIEF SUMMARY

Novel aspects of the disclosures are directed to an apparatus with footpads for navigation control in an interactive environment and method for same. In a first embodiment, the navigation controller apparatus comprises two footpads. The two footpads may rotate on an axis or be supported by a mechanical means. The navigation controller apparatus also includes sensors that detect the movement of each footpad. The apparatus includes a computing device that transmits and receives signals from the plurality of sensors representing the rotation of each footpad to a virtual reality system.

In a second embodiment, novel aspects of the present disclosure describe a method for navigation control using a navigation controller apparatus. The method includes the steps of stabilizing two footpads through a mechanical means. Then detecting a movement of said footpads individually or together with a sensor. The signals from the sensor(s) can be transmitted and received by a computing device.

In some embodiments, an input device may have sole flaps that provide additional input mechanisms. In some embodiments, a method of controlling movement includes control signals from sole flaps.

### BRIEF DESCRIPTION OF THE DRAWINGS

The present invention will be more fully understood by reference to the following detailed description of the preferred embodiments of the present invention when read in conjunction with the accompanying drawings, wherein:

FIG. 1 illustrates a virtual reality locomotion apparatus.

FIG. 2 illustrates the virtual reality locomotion apparatus.

FIG. 3 illustrates a perspective view of the virtual reality locomotion apparatus on a rotatable platform.

FIG. 4 illustrates a perspective and partially cut-away view of the virtual reality locomotion apparatus.

FIG. 5 illustrates a top and partially cut-away view of an exemplary embodiment of the virtual reality locomotion apparatus.

FIG. 6 is a perspective view of the virtual reality locomotion apparatus.

FIG. 7 illustrates the virtual reality locomotion apparatus with environmental simulators.

FIG. 8 illustrates a block diagram of components of the virtual reality locomotion apparatus.

FIG. 9 is a flowchart of a process for using the virtual reality locomotion apparatus with a virtual reality system.

FIG. 10A illustrates a side and partially cut-away view of the navigation controller apparatus.

FIG. 10B illustrates a side and partially cut-away view of the navigation controller apparatus.

FIG. 11A illustrates a perspective and partially cut-away view of the navigation controller apparatus.

FIG. 11B illustrates a perspective and partially cut-away view of the navigation controller apparatus with staggered footpads.

FIG. 12 illustrates a side view of a navigation controller apparatus in an entertainment environment.

FIG. 13 illustrates network interactions of the navigation controller apparatus.

FIG. 14A illustrates a chair mounted navigation controller apparatus.

FIG. 14B illustrates a footpad arrangement for a chair mounted navigation controller apparatus.

FIG. 15 illustrates a chair mounted navigation controller apparatus.

FIG. 16A is an illustration of a chair mounted navigation controller.

FIG. 16B is an illustration of a motor and transmission assembly.

FIG. 17 is an illustration of a screenshot for the configurator.

FIG. 18A is a screenshot illustration of a configurator with a first switch and pedal configuration.

FIG. 18B is a screenshot illustration of a configurator with a second switch and pedal configuration.

FIG. 19A is an illustration of a configurator to generate multiple customized configurations for a particular game.

FIG. 19B is an illustration of the customized configurations for particular games.

FIG. 20 is a block diagram illustration of a chair mounted navigation controller.

FIGS. 21A-21C illustrate a navigation controller and rotating platform configured to receive a chair.

FIG. 22A is a perspective view of a foot-operated input device in an open position.

FIG. 22B is a perspective view of a foot-operated input device in a closed position.

FIG. 22C is a perspective view of a foot-operated input device in a partially open position.

FIG. 22D is a front view of a foot-operated input device in an open position.

FIG. 22E is a front view of a foot-operated input device in a closed position.

FIG. 22F is a front view of a foot-operated input device in a partially open position.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION

Several embodiments of Applicant's invention will now be described with reference to the drawings. Unless otherwise noted, like elements will be identified by identical numbers throughout all the figures. The invention illustratively disclosed herein suitably may be practiced in the absence of any element that is not specifically disclosed herein.

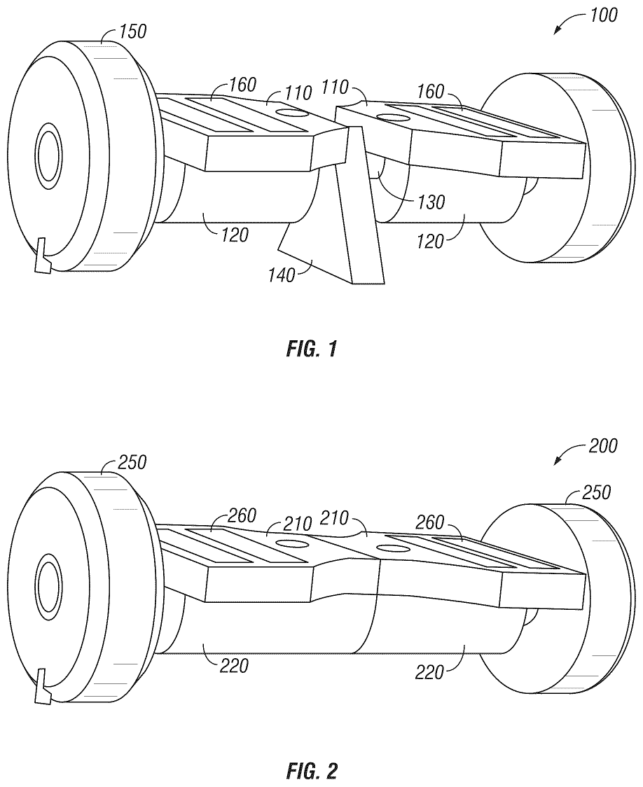

FIG. 1 illustrates an exemplary embodiment of a virtual reality locomotion apparatus. In an exemplary embodiment, the virtual reality locomotion apparatus 100 connects to a virtual reality system and simulates locomotion in the virtual reality environment generated by the virtual reality system. The virtual reality locomotion apparatus 100 allows the user to control the locomotion simulation by actuating the various components of the locomotion apparatus 100 to simulate control of virtual reality locomotion. For example, a user can actuate the locomotion apparatus 100 in a certain pattern or orientation to simulate turning left or right in the virtual reality environment.

To operate the exemplary embodiment of the locomotion apparatus 100, the user stands on the footpads 110 of the locomotion apparatus 100. The footpads 110 are disposed on an axle 130 and axial housings 120. The axial housings 120 contain the components for actuating the locomotion apparatus 100. The user can use his feet to actuate the footpads 110, and the footpads 110 and axial supports 120 rotate on the axle 130. The footpads 110 and corresponding axial housings 120 can rotate independently of each other. For example, the left footpad can rotate in an opposite direction from that of the rotational direction of the right footpad. Different rotational orientations of the footpads 110 can simulate changes in direction of locomotion in a virtual reality system.

In an exemplary embodiment, the user can indicate a certain left or right rotation in a virtual reality environment by angling one footpad forward and another footpad backward. For example, to turn counter-clockwise around an axis passing perpendicularly through the center of the device, the user can angle the left footpad down by using the heel of his left foot and can angle the right footpad down by using the ball of his right foot. Similarly, to turn clockwise around an axis passing perpendicularly through the center of the device, the user can angle the left footpad down by using the ball of his left foot and can angle the right footpad down by using the heel of his left foot. Generally, to rotate in either direction, the user can angle the footpads 110 in different and opposite directions to get the correct locomotion rotation in the virtual reality environment.

Additionally, the user can indicate forward or backward motion or locomotion in the virtual reality environment by angling both footpads 110 in a particular direction. For example, to move forward in the virtual reality environment, the user can angle the left footpad and right footpad down by using the balls of both feet, and to move backward in the virtual reality environment, the user can angle the left footpad and right footpad down by using the heels of both feet. If the user angles one footpad more than the other footpad, the user's movement in the virtual reality environment will be in an arc and the front of the user's body in the virtual reality environment will rotate while moving so that the user's body faces the forward direction of the tangent of the arc—whether traveling backward or forward.

In the illustrative embodiment of FIG. 1, the axle 130 is disposed on a stanchion 140 that serves to support the axle 130 and accordingly the weight of the user when he stands on the locomotion apparatus 100. The manner in which the axle 130 passes through and supported by the stanchion 140 is dictated by the connection means between the axle 130 and the stanchion 140. For example, the stanchion 140 can comprise a mount upon which the axle sits and rotates. The connection between the axle 130 and the stanchion 140 can use any other currently available or later developed technology for connecting the two components.

The present exemplary embodiment comprises a stanchion 140 disposed between the footpads. However, in other embodiments, more than one stanchion can be used to support the weight of the users, and stanchions can comprise any arrangement to support the axle 130 and the locomotion apparatus 100. For example, a stanchion can be placed on each end of the locomotion apparatus 100 instead of between the footpads 110. Such stanchion arrangement can provide more support to the apparatus 100 when a user stands on the locomotion apparatus 100. Further, the stanchion 140 can have any shape to accommodate supporting the axle 130 and the footpads 110.

Also shown in the illustrative embodiment of FIG. 1 are wheels 150 that serve to give impression of locomotion. These wheels 150 can also act as stanchions to support the locomotion apparatus 100 when a user stands on the footpads 110.

In one embodiment, strips 160 are disposed of on the top side of the footpads, and these strips 160 are meant to provide friction and stability to the user as he stands on the footpads. Another embodiment uses the strips 160 as sensors, which are discussed in detail below.

The operation of the locomotion apparatus 100 is based on the detection of changes in the footpads 110 by sensors and actuation of motors and environmental simulators in response. These sensors (not illustrated) and motors (not illustrated) can be disposed inside the locomotion apparatus, i.e., inside the footpads 110, the axial housings 120, the stanchion 140, or the wheels 150. Information from the sensors and to the motors are processed by a processor (not illustrated) also disposed inside the locomotion apparatus, and an I/O controller manages the communication between the processor, the sensor, and motors. The processor and the I/O controller can also manage communication from the locomotion apparatus to the virtual reality system. More detail about these components of the locomotion apparatus is discussed below.

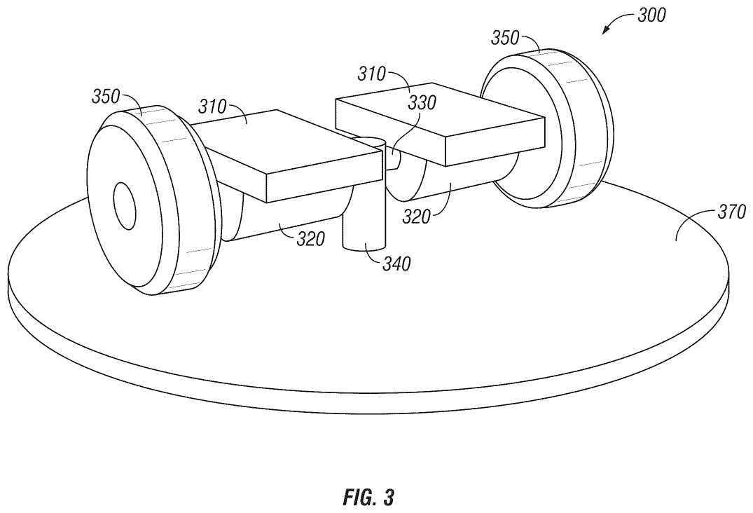

FIG. 2 illustrates a perspective view of an exemplary embodiment of the virtual reality locomotion apparatus. In this illustrative embodiment, the wheels 250 act as stanchions that keep the locomotion apparatus 200 stationary and support the weight of the user during use of the locomotion apparatus 200. In the present exemplary embodiment, the footpads 210 and the axial housings 220 are designed and shaped to meet at a central plane bisecting the locomotion into two symmetrical halves. Similar to the embodiment of FIG. 1, the present exemplary embodiment comprises an axle (not illustrated) that passes through the axial housings 220 and connects the two wheel stanchions 250. The axle is designed to connect to the center of the wheel stanchions 250. The footpads 210 and axial housings 220 can still rotate independently while disposed on the axle.

FIG. 3 illustrates a perspective view of an exemplary embodiment of the virtual reality locomotion apparatus on a platform. In the present exemplary embodiment, the locomotion apparatus 300 rotates around a fixed point (the fixed point being the central pivot 340), and the user is able to feel the movement of the locomotion apparatus 300 around the fixed point on the platform 370. Because the locomotion apparatus 300 is fixed to the platform 370, the user will not encounter any obstacles in real life. In the present exemplary embodiment, the wheels 350 act to support the user's weight and the central pivot 340 serves to keep the locomotion apparatus 300 connected to and attached to the platform 370. The central pivot 340 rotates on an axis perpendicular to the platform 370 and that passes through the center of the platform 370. The rotation of the footpads 310 in particular orientations actuate the rotation of locomotion apparatus 300 around the axis through which the central pivot 340 passes. Actuating the rotation of the locomotion apparatus can include actuating the wheels 350 in a certain orientation corresponding to the orientation of the footpads 310 by the user.

In an exemplary embodiment, the user can indicate a certain left or right rotation in a virtual reality environment by angling one footpad forward and another footpad backward and for rotation of the locomotion apparatus 300. For example, to rotate counterclockwise, the user can angle the left footpad down by using the heel of his left foot and can angle the right footpad down by using the balls of his right foot. Similarly, to rotate clockwise, the user can angle the left footpad down by using the balls of his left foot and can angle the right footpad down by using the heel of his left foot. Generally, to rotate in either direction, the user can angle the footpads 310 in different and opposite directions to get the correct locomotion rotation in the virtual reality environment and to actuate the rotation the locomotion apparatus 300.

The present exemplary embodiment can be used to indicate a forward or backward motion or locomotion using similar footpad orientations as the illustrative embodiments of FIGS. 1 and 2. For example, to move forward in the virtual reality environment, the user can angle the left footpad and right footpad down by using the balls of both feet, and to move backward in the virtual reality environment, the user can angle the left footpad and right footpad down by using the heels of both feel. However, because the locomotion apparatus 300 of the present exemplary embodiment is fixed in position by the central pivot 340, the user will not be able to experience or feel any forward or backward motion of the locomotion apparatus 300 itself in real life. Forward and backward motion or locomotion in the virtual reality environment can still be simulated by environmental simulators which are discussed below.

Since the apparatus 300 can travel in an arc when the footpads 310 are angled to different degrees, but in the same direction (either forward or backward). The rotation of the apparatus 300 (and the user's body) will correspond to the tangent of the arc on which the user is ‘traveling’ in the virtual environment.

In one enbodiment, the rotation of the user is controlled by output of the virtual reality system rather than by an autonomous action of the apparatus 300 in response to the foot movements. This enables support of a possible situation in virtual reality where the “movement of the user” is blocked in the virtual environment due to an obstacle and the rotation of the user should correspondingly be blocked. A short motor action back and forth may be actuated to simulate hitting the obstacle.

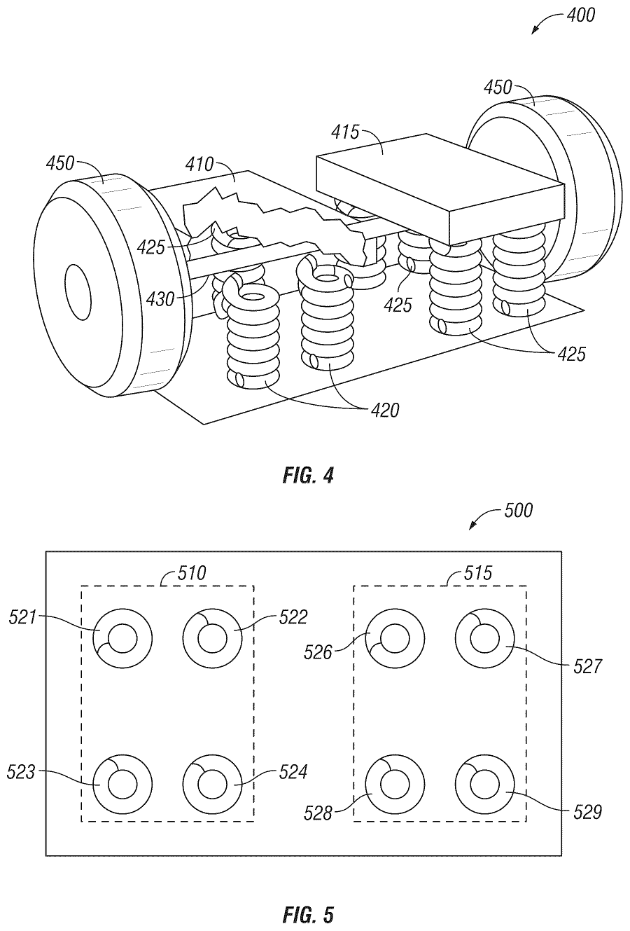

FIG. 4 illustrates a perspective and partially cut-away view of an exemplary embodiment of the virtual reality locomotion apparatus. Similar to the embodiment of FIG. 1, the wheels 450 are optionally non-functional and give the impression of motion and locomotion to the user. The user interacts with the footpads 410 and 415 to create any motion or locomotion in the virtual reality system, and the footpads 410 and 415 in the present exemplary embodiment are supported by springs 420 and 425 for footpads 410 and 415 respectively. The user can actuate the footpads 410 and 415 in a similar manner as the footpads 100 in FIG. 1. For example, to turn left, the user can angle the left footpad down by using the heel of his left foot and can angle the right footpad down by using the balls of his right foot. Similarly, to turn right, the user can angle the left footpad down by using the balls of his left foot and can angle the right footpad down by using the heel of his left foot. The angling of the footpads creates a vertical downward force against the springs 420 and 425 upon which the footpads 410 and 415 are disposed.

The force on the springs 420 and 425 can be detected by sensors (not illustrated). In one embodiment, the springs 420 and 425 themselves can be sensors via being piezo-electric, and any force exerted on them can be transformed into an electrical signal that can be interpreted by a processor. In another embodiment, the springs 420 and 425 are located on top of sensors, which can be piezo-electric sensors, and the sensors detects any changes in vertical downward force on the springs 420 and 425, which then are then sent to a processor for interpretation.

Any number of springs 420 and 425 and arrangement thereof can be used for the footpads 410 and 415. The present exemplary embodiment includes four springs 420 for footpad 410 and four springs 425 for footpad 415. The springs 420 for footpad 410 are positioned near the four corners of the footpad 410 (not all springs illustrated) and the springs 425 for footpad 415 may be positioned near the four corners of the footpad 415 (not all springs illustrated).

In the present exemplary embodiment, the footpads 410 and 415 are connected to the wheels 450 by an axle 430, and in other embodiments, the footpads 410 and 415 are connected to the wheels by other currently available or later existing mechanisms for connecting these components. The axle connects the centers of the wheels 450 and is disposed on the bottom sides of the footpads 410 and 415. The axle stabilizes the two footpads and in one embodiment, the footpads 410 and 415 can rotate around the axis formed by the axle 430. In one embodiment, the footpads 410 and 415 comprises ports on the bottom sides of the footpads 410 and 415 through which the axle 430 passes, and thereby allowing for rotation of the footpads 410 and 415 on the axle 430. Optionally, axial housings similar to those shown in FIGS. 1-3 can be incorporated with the footpads 410 and 415 to accommodate the axle 430.

In an additional embodiment, each footpad 410 and 415 can be supported by a footpad pivot (not illustrated). These footpad pivots allow the footpads 410 and 415 to tilt in any direction while the footpads 410 and 415 are supported by the springs 521-524, and 526-529, or any currently available or later developed means of supporting the footpads 410 and 415. These footpad pivots are shaped to allow for the tilting of the footpads 410 and 415, such as a pyramid, cone, or post, and these footpad pivots can connect to the footpads 410 and 415 via a ball joint mechanism.

FIG. 5 illustrates a top view of an exemplary embodiment of the virtual reality locomotion apparatus. FIG. 5 illustrates the footpads 510 and 515 in dotted lines so the placement of the springs 521-524, and 526-529 underneath the footpads 510 and 515 are more clearly defined. As mentioned with regards to the exemplary embodiment illustrated in FIG. 4, the springs 521-524, and 526-529 are located near the corners of the footpads 510 and 515.

Sensors (not illustrated) connected to the springs 521-524, and 526-529 detect any changes in the pressure or force exerted against the springs 521-524, and 526-529. In an exemplary embodiment, the sensors can detect changes in pressure or force exerted on the springs and transmit these detected changes in pressure or force to a virtual reality system, and the virtual reality system will in turn affect the user's visual display of the virtual reality environment according to a set of instructions configured to relate to the positions of the footpads. One example of a configuration of instructions is shown in the below Table 1:

TABLE 1

| Motion in Virtual Reality | | |
|---|---|---|
| Environment | Left Footpad 510 | Right Footpad 515 |
| Rotate Counterclockwise | 523 + 524 | 526 + 527 |
| Rotate Clockwise | 521 + 522 | 528 + 529 |
| Forward | 521 + 522 | 526 + 527 |
| Reverse/Backward | 523 + 524 | 528 + 529 |
| Ascending | 522 + 524 | 527 + 529 |
| Descending | 521 + 523 | 526 + 528 |

Any combination or arrangement of sensors and/or springs may be used to effectuate different motions and locomotion in a virtual reality environment, and Table 1 and FIG. 5 provide an example of a combination and arrangement of sensors and/or springs in an exemplary embodiment.

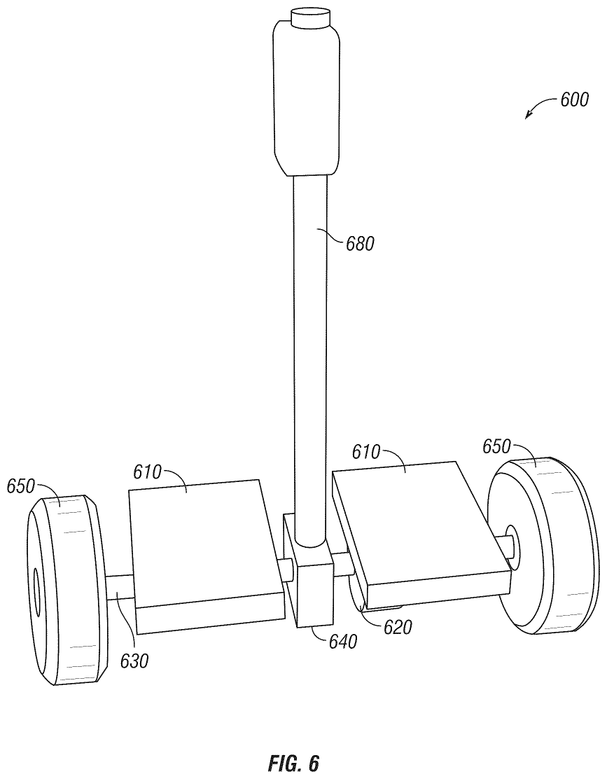

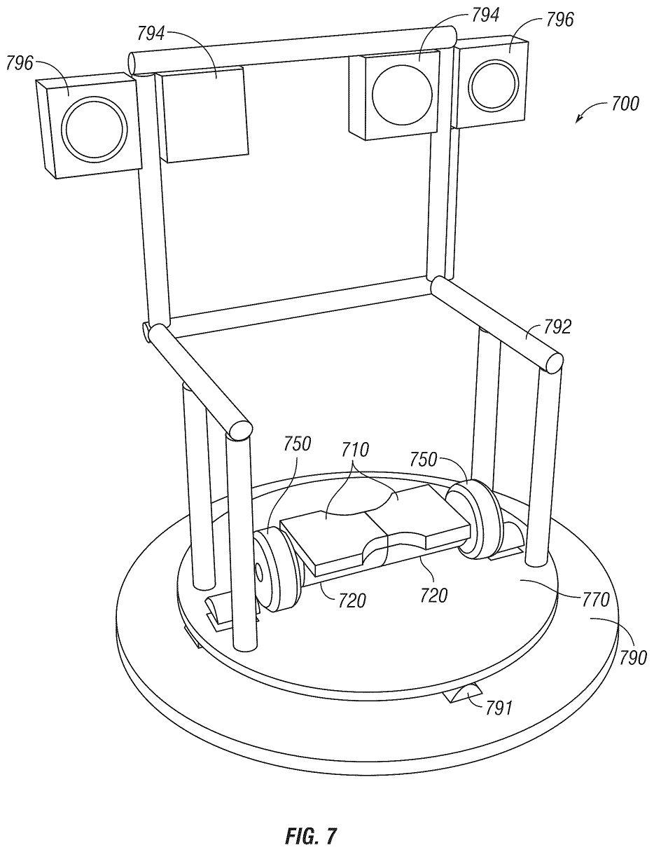

FIG. 6 is a perspective view of an exemplary embodiment of the virtual reality locomotion apparatus. This present exemplary embodiment of the virtual reality locomotion apparatus 600, like FIGS. 1-3, includes footpads 610 and axial housings 620 that rotate around an axle 630. The axle 630 passes through and is stabilized by the central stanchion 640, and optionally, the axle 630 can be stabilized by wheels 650 that can act as additional support for the locomotion apparatus 600. This present exemplary embodiment includes a central joystick 680 that a user can use to affect the visual display from the virtual reality system.

In one embodiment, the central joystick 680 is disposed on the central stanchion 640, and the connection between the central joystick 680 and the central stanchion 640 can comprise a ball-joint mechanism that detects any changes in orientation of the central joystick 680. A ball-joint mechanism for the joystick 680 allows the user to manipulate the user's visual display from the virtual reality system.

In another embodiment, the central joystick 680 passes through the central stanchion 640 and is disposed on the axle 630, and accordingly the central joystick 680 rotates on the axle 630 and around the axis through which the axle 630 passes. The rotation of the central joystick 680 can simulate ascent and descent of the user in the virtual reality environment, or can allow the user to manipulate the user's visual display from the virtual reality system.

While the present exemplary embodiment includes the central joystick 680 disposed between the footpads 610, in yet another embodiment, the locomotion apparatus 600 can include more than one joystick for use and operation by the user. Joysticks can be disposed on the stanchions at the ends of the locomotion apparatus 600, and any number of joysticks can be used with the locomotion apparatus 600.

Any currently available or later developed mechanism for connecting the central joystick 680 to the central stanchion 640 or to the axle 630 may be used, and any currently available or later developed sensor technology may be used to detect any motion or movement of the central joystick 680. Furthermore, the present exemplary embodiment of FIG. 6 can incorporate any features, principles, and/or techniques used with the exemplary embodiments of FIGS. 1-5.

FIG. 7 illustrates an exemplary embodiment of the virtual reality locomotion apparatus with environmental simulators. The illustrative embodiment of FIG. 7 is similar to the exemplary embodiment of FIG. 3 in that FIG. 7 illustrate a locomotion apparatus 700 fixed to a platform 770 by a wheel stanchions 750. The present exemplary embodiment of the locomotion apparatus 700 does not rotate on top of the platform 770 like the locomotion apparatus of FIG. 3. Instead, the platform 770 rotates on a base 790 so that the user can feel the locomotion or motion displayed in the virtual reality environment in real life. The platform 770 is fixed to the base 790 by the wheel stanchions 750 or any other currently available or later developed mechanism for affixing the platform 770 to the base 790, so that the platform 770 can rotate around an axis passing through the central pivot 740. The exemplary embodiment includes rollers 791 disposed between the base 790 and the platform 770. These rollers 791 actuate when the user changes the orientation of the footpads 710. Any currently available or later developed mechanism for rotating the platform 770 on the base 790 can be used for the exemplary embodiment.

As mentioned with FIG. 3, the user can indicate a certain left or right rotation in a virtual reality environment by angling one footpad forward and another footpad backward and for rotation of the locomotion apparatus 700. For example, to turn left, the user can angle the left footpad down by using the heel of his left foot and can angle the right footpad down by using the balls of his right foot. Similarly, to turn right, the user can angle the left footpad down by using the balls of his left foot and can angle the right footpad down by using the heel of his left foot. Generally, to turn in any direction, the user can angle the footpads 710 in different and opposite directions to get the correct locomotion rotation in the virtual reality environment and to actuate the rotation of the platform 770 on the base 790.

Further, the present exemplary embodiment comprises environmental simulators supported on a frame 792 disposed on the platform 770. The frame 792 can be shaped and oriented in any configuration. In another embodiment, the frame 792 can be disposed on the base 790 instead of the platform 770 and environmental simulators can located anywhere on the frame surrounding the user and the platform 770 to give the user as close to a full-immersion experience with the virtual reality system.

The environmental simulators can comprise fans 794 and speakers 796 that provide real-life sensations to the user of the virtual reality environment. For example, the fans 794 can provides a touch-based sensory input to the user: while the virtual reality system cannot simulate any touch-based input, the fans 794 can actuate so that the user can visual the effects of wind and can feel air circulation on his wind that emulates the wind of the virtual reality environment. Similarly, where the virtual reality system does not provide any audio device such as headphones, the speakers 796 of the present exemplary embodiment can provide audio-based input.

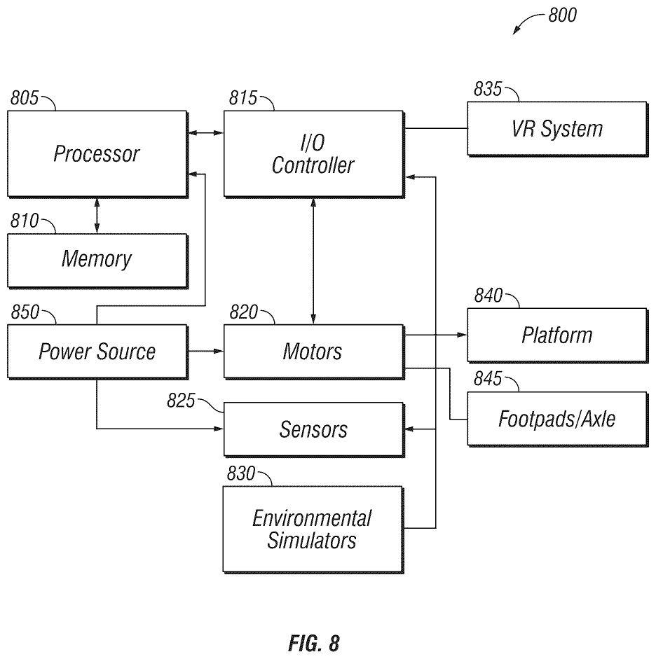

FIG. 8 illustrates a block diagram of components of an exemplary embodiment of the virtual reality locomotion apparatus. In an exemplary embodiment, the virtual reality locomotion apparatus 800 can be controlled by a processor 805 connected to memory 810, which includes readable computer instructions for the processor 805. The processor 805 communicates with an I/O (input/output) controller 815 that manages the input and output signals to the various input and output devices and controllers of the virtual reality locomotion apparatus 800. These input and out devices include the motor 820, sensors 825, and environmental simulators 830. The I/O controller 815 also manages communication with the virtual reality (VR) system 835, and the communication can be through a wired connection or through a wireless connection. Additionally, a power source 850 is included in the locomotion apparatus 800 so as to supply power to various components, and the power source may be a battery or an AC adapter. In an exemplary embodiment, the virtual reality locomotion apparatus 800 contains a subset of these components. For example, the processor 805, memory 810, I/O controller 815, motor 820, sensors 825, and environmental simulators 830 are contained inside the virtual reality locomotion apparatus 800 as disclosed previously. Some environmental simulators 830, the platform 840, the power source 850, and the VR system 835 are components that are not contained inside the locomotion apparatus 800 in some exemplary embodiments.

The processor 805 reads computer-readable instructions from memory 810 and upon input from the VR system 835 through the I/O controller 815, transmits actuation signals to various input and output devices through the I/O controller 815. The processor 805 through the I/O controller 815 controls the motor 820, speakers 825, and environmental simulators 830. The processor 805 in turn through the I/O controller 815 receives information from the sensors 825, and then after processing information from these devices, passes the information through the I/O controller 815 to the VR system 835. The information received by the I/O controller 815 may be wired or wireless. One of ordinary skill in the art would understand how to select, program, and use the processor 805, memory 810, and I/O controller 815 for the locomotion apparatus 800 as disclosed herein.

As mentioned previously, the motor 820 is controlled by the processor 805 through the I/O controller 815. The motor 820 automates and actuates the virtual reality locomotion apparatus 800. In one embodiment, the motor 820 can actuate the axle or the footpads 845 of the locomotion apparatus 800 to stabilize the footpads 845 for use by the user. In another embodiment, the motor 820 actuates the rotation of the locomotion apparatus 800 on a platform 840, such as in the locomotion apparatus of FIG. 3. The motor 820 can actuate the movements and rotation of the footpads and/or axle 845. In yet another embodiment, the motor 820 actuates the rotation of the platform 840 on the base 790 as shown in FIG. 7, and the footpads are stabilized in the nominal parallel position by springs and/or solenoids. The locomotion apparatus 800 can comprise any number of motors to actuate its various components. One of ordinary skill in the art would understand how to choose and implement the motors for the locomotion apparatus 800.

As mentioned previously, the sensors detect changes in the footpads of the locomotion apparatus 800 and transmits signals to the processor 805 through the I/O controller 815. The sensors 820 can include gyroscopes, piezo-electric sensors, and any other type of sensors, currently available, or later developed, that can be used to detected changes in the footpads of the locomotion apparatus 800. One of ordinary skill in the art would understand how to choose and implement sensors 820 for the locomotion apparatus 800.

Also mentioned previously, the environmental simulators 830 are controlled by the processor. The environmental simulators 830 can include vibrators, fans, speakers, and any other device that can be used to simulate in real-life the actions, sounds, and environment inside the virtual reality environment. One of ordinary skill in the art would know and understand how to implement the environmental simulators 830 for the locomotion apparatus 800 in response to input and output from the virtual reality system 835.

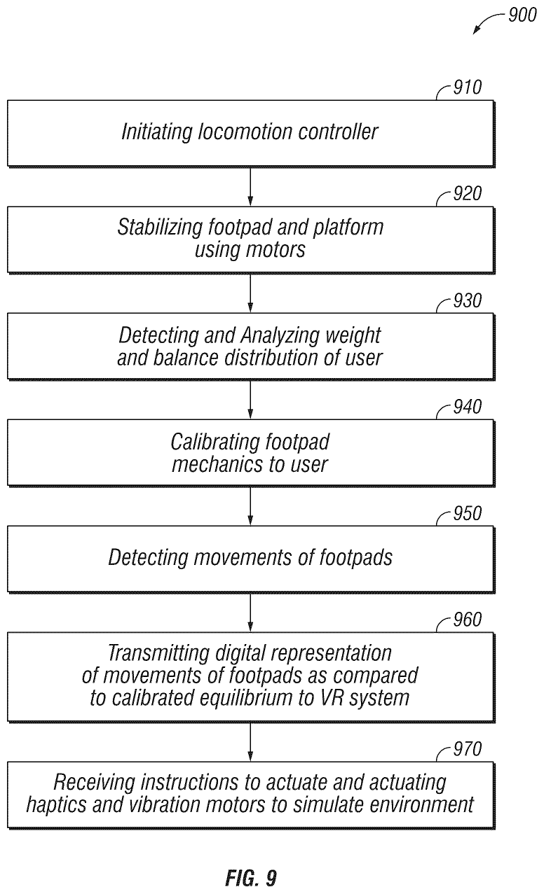

FIG. 9 is a flowchart of a process for using the virtual reality locomotion apparatus with a virtual reality system. The steps of flowchart 900 may be implemented by a virtual reality locomotion apparatus, such as the virtual reality locomotion apparatus exemplified in and disclosed in FIGS. 1-8.

The process begins by initializing the locomotion apparatus (step 910). The user can press a power button that will begin initializing the processor and other components of the locomotion apparatus.

Once the locomotion apparatus is initialized, the footpads and platform are stabilized using motors, solenoids, or springs of the locomotion apparatus (step 920). Users may leave the footpads at an angle to the ground or to the platform, or the platform may be rotated away from its initial position on the base. Accordingly, the locomotion apparatus resets the position of the footpads and platform to their original and/or initial orientation and position. Resetting the footpads and platform allows a user to more easily mount the locomotion apparatus.

Once the footpad and platform are stabilized, a user can stand on the locomotion apparatus and the locomotion apparatus detects and analyzes the weight and balance distribution of the user on the locomotion apparatus (step 930). Because each user is different, the locomotion apparatus detects how the user stands on the locomotion apparatus by detecting the weight and balance distribution of the user on the sensors and/or springs of the locomotion apparatus.

Then, the locomotion apparatus calibrates the footpad mechanics to the user (step 940). Using the detected and analyzed weight and balance distribution of the user from step 930, the locomotion apparatus calibrates the footpad mechanics to respond to the user. Changes in the pressure of the footpads can differ so the locomotion apparatus calibrates these changes in motion for users.

The user can then operate the locomotion apparatus using their feet in response to a visual display by the virtual reality system, and the locomotion apparatus detects movements of the footpads (step 950). As mentioned previously, the locomotion apparatus detects the movements of the footpads using sensors.

The locomotion apparatus transmits a digital representation of the rotation of the footpads to the virtual reality system (step 960), and this digital representation may be in comparison to the calibrated equilibrium determined by the locomotion apparatus in step 930. The digital representation is generated based on signals from the sensors of the locomotion apparatus, and the digital representation can be customized based on the virtual reality system used with the locomotion apparatus.

The locomotion apparatus then receives instructions from the virtual reality system to actuate various components, and the locomotion apparatus actuates environmental simulators in response to the instructions from the virtual reality system (step 970). The instructions from the virtual reality system can include instructions to actuate some of the environmental simulators of the locomotion apparatus, such as vibrators, fans, speakers, and any other device that can be used to simulate in real-life actions and things in a virtual reality environment. The locomotion apparatus can be implemented to interface with any currently available or later developed virtual reality system.

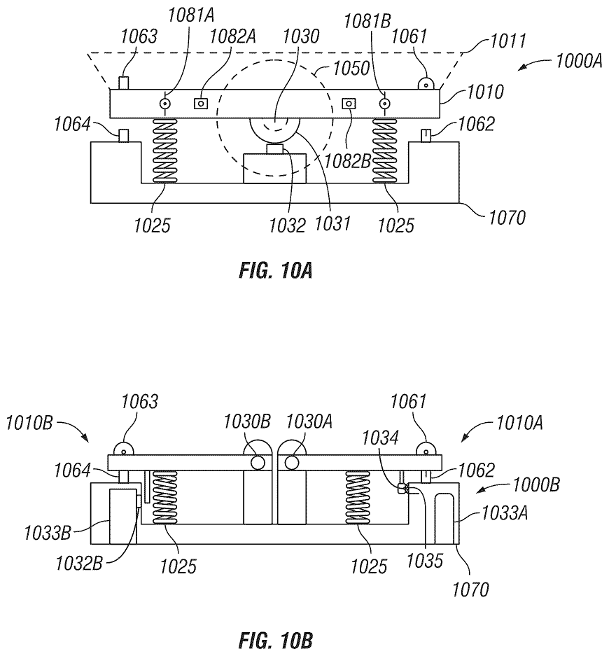

FIG. 10A illustrates a navigation controller apparatus 1000A that allows a user (not illustrated) to control a computing device or other digital or physical devices. For example, the navigation controller apparatus 1000A may allow for the interactive control of a computer game, or user interface elements of a display screen, and/or allow for physical interactions such as exercise or therapy from a stationary apparatus or platform such as the navigation controller apparatus 1000A. The navigation controller apparatus 1000A may include at least two footpad(s) 1010 that may move separately and/or independently of one another. In some embodiments, the footpad(s) 1010 may have a lip 1011 that surrounds them to prevent a user's foot (not illustrated) from leaving the surface of the footpad 1010 when the navigation controller apparatus 1000A is in use.

The footpad(s) 1010 may have an axle 1030 that passes through the at least a portion of the body of the footpad(s) 1010. The axle 1030 may be supported and/or coupled to a magnet 1031. In at least one example, the magnet 1031 may couple to the footpad(s) 1010. The magnet 1031 may allow the movement of the footpad(s) 1010 to be detected by a sensor 1032. The sensor 1032, in at least one embodiment, is a Hall effect sensor. In some embodiments, the magnet 1031 may alternatively be a light source, or some other electric or magnetic field emitting device or element that can be monitored by the sensor 1032. The sensor 1032 may be coupled to a computing device 1033. The computing device 1033 may connect to a display or interface device (not illustrated) that is configured to receive information from the navigation controller apparatus 1000A.

The footpad(s) 1010 may also include one or more sensors on and/or within the footpad(s) 1010. The sensors may include a foot detection sensor 1061, a foot enabled sensor 1063, and/or other sensors configured to allow detection and interaction with a user and the footpad 1010. The foot detection sensor 1061 (or foot sensor) may be beam interruption, range detection, pressure detection, or other sensors and/or circuits that would allow for a computing device to know when and/or how a user's foot (not illustrated) has interacted with the footpad(s) 1010. The foot enabled sensor 1063 may be switch(s), pressure detection, directional detection, and/or other sensors and/or circuits that would allow when and/or how an action is to occur.

In at least one embodiment, the axle 1030 may be supported by a wheel 1050 or other form of stanchion. The wheel 1050, and/or a wheel like stanchion may also be supported by a base 1070. The base 1070 can also provide support to the spring(s) 1025. In at least one example, the wheel 1050 supports the footpad(s) 1010 and/or the axle 1030. In at least one embodiment, the spring(s) 1025 can provide resistance and/or support to the footpad(s) 1010 keeping them at a first or neutral position until a user causes the footpad(s) 1010 to be repositioned to a second position (toe up or toe down). In at least one example, a first position would have the footpad(s) 1010 parallel to a surface supporting the navigation controller apparatus 1000A, while a second position would place the footpad(s) 1010 at an angle positive or negative of a line that is parallel to a surface supporting the navigation controller apparatus 1000A. In another example, a first position would have the footpad(s) 1010 at a first angle to a surface supporting the navigation controller apparatus 1000A, while a second position would increase or decrease the angle of the footpad(s) 1010 positively or negatively from the first angle. It would be understood that the footpad(s) may be placed in any number of positions, and could include a third position, a fourth position, a fifth position, and additional positions. In some embodiments, the resistance provided by the springs may be adjusted to allow for increased pressure and/or resistance to a user's interaction.

The base 1070 may also provide support for sensors that can assist in determining the position of the footpad(s) 1010. The sensor 1062, and/or sensor 1064 may be a switch(s), light detector(s), distance measuring, pressure sensing, and/or other sensing and/or measurements devices or circuits. For illustration purposes, FIG. 10A shows sensor 1062 as a measurement sensor and sensor 1064 as a switch. It would be understood that different sensors may be used individually, and/or in combination.

In at least one embodiment, the footpad(s) 1010 may house at least one feedback device 1081A and/or 1081B (collectively 1081) for haptic feedback. The haptic feedback may be in response to actions in a virtual reality environment, and/or may come from a remote computing device such as a game server or entertainment system. In some examples, the haptic feedback may be a response to an action or trigger from one of the various sensors of the navigation controller apparatus 1000A. The feedback device(s) 1081 may be a motor, vibration motors, and/or other actuation devices. In some embodiments, the footpad(s) 1010 may also house at least one tilt sensor 1082A and/or 1082B (collectively 1082) that allow for additional sensing of various movements of the footpad(s) 1010. For example, the footpad(s) 1010 may be tilted and/or rotated in a +/−Y direction, +/−X direction, and/or in +/−Z direction all of which could be sensed with a tilt sensor 1082. In at least one example, the tilt sensor 1082 is an accelerometer and/or other motion or position sensing device.

FIG. 10B illustrates a navigation controller apparatus 1000B allowing for control of a computing device or other digital or physical devices. The navigation controller apparatus 1000B can include footpad 1010A and footpad 1010B. In at least one embodiment, the footpad(s) 1010A and/or 1010B are positioned in a manner that is mirrored. For example, a first footpad 1010A may be raised at what can be called the toe end 1012A of the navigation controller apparatus 1000B, while the second footpad 1010B is raised at what can be the heel end 1012B of the navigation controller apparatus 1000B. The footpads 1010A and/or 1010B may be lower at their opposing ends 1013A and/or 1013B. In at least one embodiment, the footpads 1010A and/or 1010B can be rotatable around an axis 1030A and/or 1030B. The axis 1030A and/or 1030B can be a fixed point around which the footpads 1010A and/or 1010B can rotate. The axis 1030A and/or 1030B can each have a magnet 1031 surrounding and/or coupling to them. The magnet 1031 may allow for the detection of movement by footpad 1010A and/or 1010B with a sensor 1032. In at least one embodiment, the sensor 1032is a Hall effect sensor. In other embodiments, the magnet 1031may be a light source, electric field, or other magnetic field emitting device or circuit. The sensor 1032, in some embodiments may be capable of reading and/or receiving from a light source, electric field, or other magnetic field emitting devices or circuits. In at some examples, the footpad(s) 1010 may be coupled to a gear 1034. The gear 1034 may be rotatable coupled to a measurement device 1035. In at least one embodiment, the measurement device 1035 is a potentiometer, or other rotational measurement device. The measurement device 1035 may also be coupled to a computing device 1033A.

In some embodiments, spring(s) 1025 may support one or more sides or ends of the footpad(s) 1010A and/or 1010B. The footpad(s) 1010A and/or 1010B may also include one or more sensors on and/or within the footpad(s) 1010A and/or 1010B. The sensors may include a foot detection sensor 1061, a foot enabled sensor 1063, and/or other sensors configured to allow detection and interaction with a user and the footpad 1010A and/or 1010B. The foot detection sensor 1061 may be beam interruption, range detection, pressure detection, or other sensors and/or circuits that would allow for a computing device to know when and/or how a user's foot (not illustrated) has interacted with the footpad(s) 1010A and/or 1010B. The foot enabled sensor 1063 may be switch(s), pressure detection, directional detection, and/or other sensors and/or circuits that would allow when and/or how an action is to occur.

The sensors may also be coupled to one or more computing devices 1033A and/or 1033B. In at least one example, the computing device(s) may be housed within the base 1070. The base 1070 can provide support to the spring(s) 1025, and one or more of the sensor(s). In some embodiments, the base 1070 may also provide support for a stanchion or other element that supports the axis 1030A and/or 1030B.

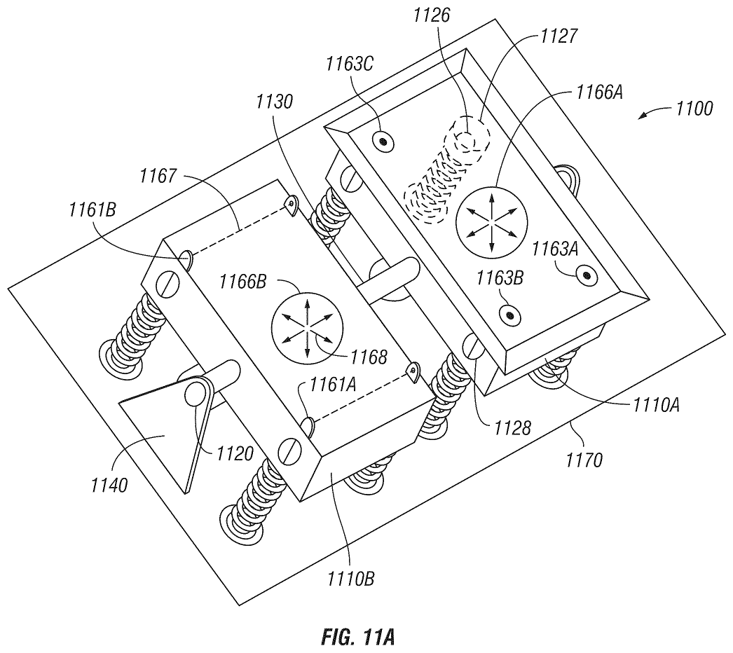

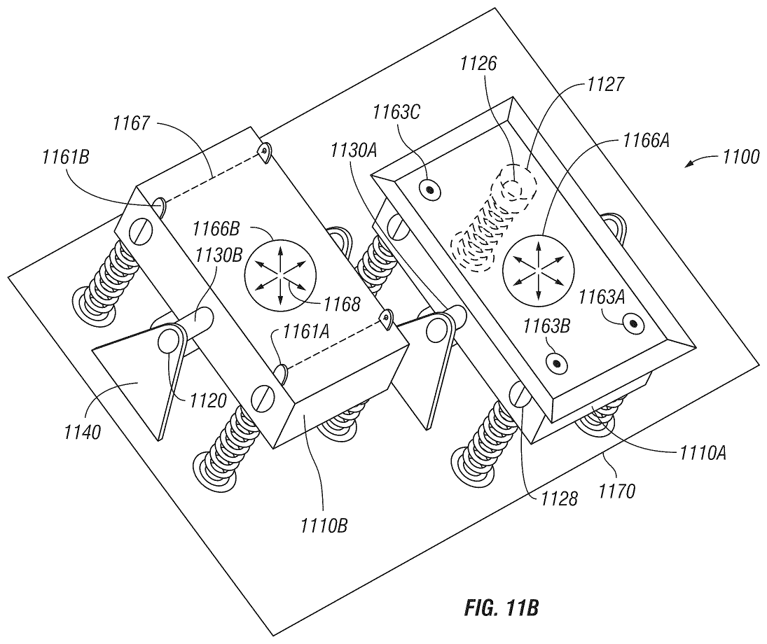

FIG. 11A is an illustration of a footpad apparatus 1100A. The navigation controller apparatus 1100A may include a first footpad 1110A and a second footpad 1110B (collectively 1110). The footpad(s) 1110 may have a lip 1111 to assist a user (not illustrated) in maintaining contact with the navigation controller apparatus 1100. In at least one embodiment, the lip 1111 may have sensor(s) along it and/or within it that can detect motion and/or other actions by a user that allow for interactions with the device. In at least one example, the footpad(s) 1110 can have sensors within and/or on their surface to allow for interactions. The sensors may include interactive or enablement sensors 1163A and/or 1163B, and/or 1163C, and/or detection sensors 1161A and/or 1161B.

In at least one example, the detection sensors 1161A and/or 1161B may be a beam interruption, range detection, pressure detection, or other sensors and/or circuits that would allow for a computing device to know when and/or how a user's foot (not illustrated) has interacted with the footpad(s) 1110. Similarly, the interaction and/or enablement sensors 1163A and/or 1163B, and/or 1163C can be switch(s), pressure detection, directional detection, and/or other sensors and/or circuits that would allow when and/or how an action is to occur. Additionally, the footpad(s) 1110 may also include a directional sensor 1166A and/or 1166B (collectively 1166). The directional sensor(s) 1166A and/or 1166B can allow a user (not illustrated) to indicate directional changes without having to remove their foot from the navigation controller apparatus 1100. For example, a user (not illustrated) that utilizes the navigation controller apparatus in a gaming environment may need to manipulate the viewing angle or direction of a character, the user could use their feet to cause the viewing angle to move by moving a directional sensor 1166A and/or 1166B without requiring a locomotion movement within the VR and/or gaming environment. It would be understood that in one example, a locomotion movement may also cause a change in the viewing angle due to a change in a character's location, or facing direction, while the directional sensor(s) 1166 would allow for a change of viewing angle without changing the character's location, or facing direction. Additionally, the directional sensor(s) 1166 may be used to generate commands and/or movement of other elements such as alerions of remote control devices, control system for a remote control device, and/or robotic limbs for robotic devices. For example, a user may utilize the footpad(s) 1110 to actuate the up and/or down motions, and/or the rotational direction of the robot, like a fixed or mobile robot, while the directional sensor(s) 1166 can allow for the control of individual limbs of the robot as selected and/or commanded by the user (not illustrated) through interactions with the navigation controller apparatus and/or a local or remote computer system (not illustrated). In another example, a user may utilize the footpad(s) 1110 to control the movements of a fixed robot such as a manufacturing robot, or may utilize the footpad(s) 1110 to control the locomotion of a mobile robot.

In some examples a user may utilize both of the directional sensors 1166A and/or 1166B to manipulate two points of reference, for example, the viewing direction of a character and a map position of a character. In additional examples, the directional sensor(s) 1166 may act as one or more keys on a keyboard. For example, a user may move a directional sensor 1166 in a first direction, and then move the footpad 1110 in a first direction, causing a secondary movement and/or reaction much like a user pressing a control key and/or a letter key and/or a directional or arrow key, or a combination or sequence of keys. In another example, when the directional sensor 1166 is neutral, footpad 1110 movement would trigger a movement in a virtual reality, remote computing system, and/or an entertainment system, but when the directional sensor 1166 is moved then movement of the footpad(s) 1166 may cause keyboard or mouse like actions to occur such as, but not limited to, a keyboard action for a mapped key, or a mouse click when the footpad 1110 is rotated in a specific direction in combination with a specific directional movement 1068 of the directional sensor 1166. Altogether the various positions of rotation of one or both directional sensor(s) 1166 may be detected and combined to determine an action or command. These actions or commands may be used to control a variety of activities within the virtual reality application such as adjusting a view (panning sideways or up or down, or zooming in or out), ascending or descending (while moving or not moving), jumping, swinging, controlling weapons or tools, opening doors, picking up items or interacting in any way. The motions of the directional sensor(s) 1166 could also be used to control a variety of movements and actions of a motor-driven device such as a robot, drone, wheelchair, or other remote control device. A movement or position change of the directional sensor(s) 1166 may be combined with a movement or position change of the one or both footpad(s) 1110 to trigger additional action or commands.

The navigation controller apparatus 1100 can include an axle 1130 that can pass through and/or traverse at least a portion of the footpad(s) 1110. In at least one example, the footpad(s) 1110 may have an aperture through which the axle 1130 can pass allowing the footpad(s) to have at least one axis of rotational freedom. The axle 1130 may be supported by one or more stanchions 1140. The stanchions 1140 may be coupled to a base, or in some embodiments may be free standing to support the navigation controller apparatus 1100. The footpad(s) 1110, in at least one example, can be supported by one or more resistive devices 1125. In at least one embodiment, the one or more resistive devices are springs, and/or adjustable springs. The resistive devices 1125 may be adjustable through an opening and/or aperture 1128 of the footpad(s) 1110. The opening and/or aperture 1128 can also allow for adjustments to be made to the resistive devices 1125. For example, in at least one example, the resistive device 1125 may have a ball and/or sphere 1126 (or other geometric object) that is capable of being received by and/or within a detection receptacle 1127. The receptacle 1127 can be configured with a sensor to know when the ball and/or sphere 1126 has been received and/or when it has reached the maximum distance it can travel within the receptacle 1127. In at least one example, the ball and/or sphere 1126, and receptacle 1127 can be combined with other sensing devices to know when the footpad(s) 1110 are in a neutral position or anywhere in between. The combination of the ball and/or sphere 1126 and receptacle 1127 allows for the detection of when the footpad(s) 1110 have reached their maximum travel distance for that axis of freedom.

FIG. 11B is an illustration of a navigation controller apparatus 1100B. The navigation controller apparatus 1100B may include a first footpad 1110A and a second footpad 1110B (collectively 1110). The footpad(s) 1110 may have a lip 1111 to assist a user (not illustrated) in maintaining contact with the navigation controller apparatus 1100B. In at least one embodiment, the lip 1111 may have sensor(s) along it and/or within it that can detect motion and/or other actions by a user that allow for interactions with the device. In at least one example, the footpad(s) 1110 can have sensors within and/or on their surface to allow for interactions. The sensors may include interactive or enablement sensors 1163A and/or 1163B, and/or 1163C, and/or detection sensors 1161A and/or 1161B.

In at least one example, the detection sensors 1161A and/or 1161B may be a beam interruption, range detection, pressure detection, or other sensors and/or circuits that would allow for a computing device to know when and/or how a user's foot (not illustrated) has interacted with the footpad(s) 1110. Similarly, the interaction and/or enablement sensors 1163A and/or 1163B, and/or 1163C can be switch(s), pressure detection, directional detection, and/or other sensors and/or circuits that would allow when and/or how an action is to occur. Additionally, the footpad(s) 1110 may also include a directional sensor 1166A and/or 1166B (collectively 1166). The directional sensor(s) 1166A and/or 1166B can allow a user (not illustrated) to indicate directional changes without having to remove their foot from the navigation controller apparatus 1100B. For example, a user (not illustrated) that utilizes the navigation controller apparatus in a gaming environment may need to manipulate the viewing angle or direction of a character, the user could use their feet to cause the viewing angle to move by moving a directional sensor 1166A and/or 1166B without requiring a locomotion movement within the VR and/or gaming environment. It would be understood that in one example, a locomotion movement may also cause a change in the viewing angle due to a change in a character's location, or facing direction, while the directional sensor(s) 1166 would allow for a change of viewing angle without changing the character's location, or facing direction. Additionally, the directional sensor(s) 1166 may be used to generate commands and/or movement of other elements such as alerions of remote control devices, control system for a remote control device, and/or robotic limbs for robotic devices. For example, a user may utilize the footpad(s) 1110 to actuate the up and/or down motions, and/or the rotational direction of the robot, like a fixed or mobile robot, while the directional sensor(s) 1166 can allow for the control of individual limbs of the robot as selected and/or commanded by the user (not illustrated) through interactions with the navigation controller apparatus and/or a local or remote computer system (not illustrated). In another example, a user may utilize the footpad(s) 1110 to control the movements of a fixed robot such as a manufacturing robot, or may utilize the footpad(s) 1110 to control the locomotion of a mobile robot.

In some examples a user may utilize both of the directional sensors 1166A and/or 1166B to manipulate two points of reference, for example, the viewing direction of a character and a map position of a character. In additional examples, the directional sensor(s) 1166 may act as a one or more keys on a keyboard. For example, a user may move a directional sensor 1166 in a first direction, and then move the footpad 1110 in a first direction, causing a secondary movement and/or reaction much like a user pressing a control key, and/or a letter key, and/or a directional or arrow key, or a combination or sequence of keys. In another example, when the directional sensor 1166 is neutral, footpad 1110 movement would trigger a movement in a virtual reality, remote computing system, and/or an entertainment system, but when the directional sensor 1166 is moved then movement of the footpad(s) 1166 may cause keyboard or mouse like actions to occur such as, but not limited to, a keyboard action for a mapped key, or a mouse click when the footpad 1110 is rotated in a specific direction in combination with a specific directional movement 1068 of the directional sensor 1166. Altogether the various positions of rotation of one or both directional sensor(s) 1166 may be detected and combined to determine an action or command. These actions or commands may be used to control a variety of activities within the virtual reality application such as adjusting a view (panning sideways or up or down, or zooming in or out), ascending or descending (while moving or not moving), jumping, swinging, controlling weapons or tools, opening doors, picking up items or interacting in any way. The motions of the directional sensor(s) 1166 could also be used to control a variety of movements and actions of a motor-driven device such as a robot, drone, wheelchair, or other remote control device. A movement or position change of the directional sensor(s) 1166 may be combined with a movement or position change of the one or both footpad(s) 1110 to trigger additional action or commands.

The navigation controller apparatus 1100B can include a first axle 1130A that can pass through and/or traverse at least a portion of the footpad 1110A, and/or a second axle 1130B that can pass through and/or traverse at least a portion of the footpad 1110B. Collectively, the axle(s) may be referred to as axle 1130. In at least one example, the footpad(s) 1110 may have an aperture through which the axle 1130 can pass allowing the footpad(s) to have at least one axis of rotational freedom. The axle 1130 may be supported by one or more stanchions 1140. The stanchions 1140 may be coupled to a base, or in some embodiments may be free standing to support the navigation controller apparatus 1100. The footpad(s) 1110, in at least one example, can be supported by one or more resistive devices 1125. In at least one embodiment, the one or more resistive devices are springs, and/or adjustable springs. The resistive devices 1125 may be adjustable through an opening and/or aperture 1128 of the footpad(s) 1110. The opening and/or aperture 1128 can also allow for adjustments to be made to the resistive devices 1125. For example, in at least one example, the resistive device 1125 may have a ball and/or sphere 1126 (or other geometric object) that is capable of being received by and/or within a detection receptacle 1127. The receptacle 1127 can be configured with a sensor to know when the ball and/or sphere 1126 has been received and/or when it has reached the maximum distance it can travel within the receptacle 1127. The combination of the ball and/or sphere 1126 and receptacle 1127 allows for the detection of when the footpad(s) 1110 have reached their maximum travel distance for that axis of freedom. With respect to FIGS. 11A and 11B, the navigation controller apparatus may be seen by a computer system as a Human Interface Device (HID) using a standard or proprietary HID protocol in emulation of a joystick, gamepad, keyboard, and/or mouse. For example, a movement detected by the navigation controller apparatus would cause transmission of joystick movements to a display screen or system.

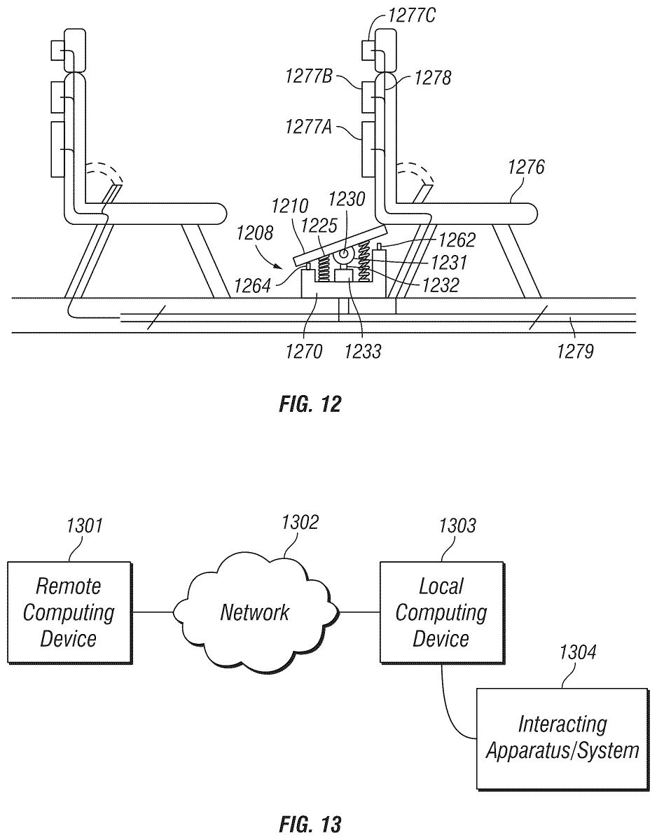

FIG. 12 is an illustration of a navigation controller apparatus or system for use in a therapy and/or entertainment environment. For example, on long airplane flights the risk of Deep Vein Thrombosis (DVT) can greatly increase if a passenger (not illustrated) does not move on a regular basis. In at least one example, the navigation controller apparatus may couple with an in-flight entertainment system 1277A and/or 1277B, and/or 1277C (collectively 1277). The in-flight entertainment system 1277A and/or 1277B, and/or 1277C may include various displays, user interface, and/or computing devices which may be coupled 1278 to a central electrical and/or control system 1279 of the aircraft. The navigation controller apparatus may be coupled to a floor and/or other fixed object of an aircraft. For example, the navigation controller apparatus can be coupled to an aircraft seat 1276, in which an inflight entertainment system 1277A and/or 1277B, and/or 1277C may be located. In other example, the base 1270 of the navigation controller apparatus may be fixed and/or coupled to the aircraft floor or seat 1276. As a user (not illustrated) operates the footpad(s) 1210 around an axle 1230, the movements may be captured and/or recorded with a magnet 1231, and Hall effect sensor 1232. The movement capture device (magnet 1231 and Hall effect sensor 1232) may include other electrical, light, wave, and/or magnetic fields that can be captured and/or recorded by a sensor that may be coupled to a computing device 1233. The movement capture device may capture and/or record the rotational movement and/or change of position of the footpad(s) 1210 within their range of motion.

In some embodiments, the footpad(s) 1210 may have sensors 1262 and/or 1264 that alert a computing device, such as the computing device 1233. In some embodiments, the computing device may be contained within and/or supported by the base 1270. In at least one example, the footpad(s) 1210 may also be supported by resistive devices 1225. The resistive devices 1225 may be adjustable, and in one embodiment may be springs. As a user (not illustrated) utilizes the navigation controller apparatus the resistance of the footpad 1210 movement may need to be modified to allow the user to increase their workout and/or therapy. This may be done via a computing device and/or user interface.

In at least one embodiment, a navigation controller apparatus in combination with the seat 1276 may allow for a user (not illustrated) to utilize the entertainment systems 1277 and/or other display system to control other devices. For example, the navigation controller apparatus may be utilized by an airman to control a drone or other aircraft remotely from a control aircraft. In other examples, the seat 1276 may be a chair or other seating device that allows a user to be seated while controlling a remote control device such as a robot, drone, quad-copter, aircraft, boat, and/or vehicle. In at least one of the said examples, a user may utilize the navigation controller apparatus to control the speed and height of a drone while utilizing a controller (not illustrated) to control other aspects of the drone flight.

In at least one embodiment, the navigation controller apparatus may also be configured to operate as a mouse, gamepad, joystick, and/or certain keyboard actions for a computer and/or other computing device. This would allow a user (not illustrated) who has lost an arm or leg to utilize the navigation controller apparatus on the floor or a table in conjunction with a computer and/or computing device. The navigation controller apparatus can be used for therapeutic uses and may allow for a user to exercise each leg, foot, ankle, knees, and/or toes individually or collectively through different positioning and/or exercises. The independent and/or separated configuration of the footpad(s) 1210 allow for individual measurement and/or exercise of various limbs, muscles, tendons, and/or ligaments. Some of the motions and/or exercise the navigation controller apparatus may allow for are flexion, extension, pronation, supination, eversion, and inversion.

In some examples, the entertainment systems 1277 may be tablets, mobile computing devices, laptops, phones, or other computing devices configured and/or capable of user interaction. Additionally, the navigation controller apparatus may have motors or other actuators that are capable of providing haptic or vibrational feedback. The feedback may in some examples serve as reminders for a user to exercise and/or utilize the device. In other examples, the feedback can be utilized as a training tool to provide a user with haptic information regard the next action as determined by the computing device or other remote computing device running a computer executable program and/or code from a machine readable media. Other visual and/or auditory signals may be provided through the entertainment system 1277 or other computing devices coupled to the navigation controller apparatus. In some examples, the navigation controller apparatus may be coupled to a chair base. In other examples, the navigation controller apparatus can be placed and/or secured to a footrest that is coupled to a chair and/or the base of a chair to allow the navigation controller apparatus to rotate with the chair as it rotates.

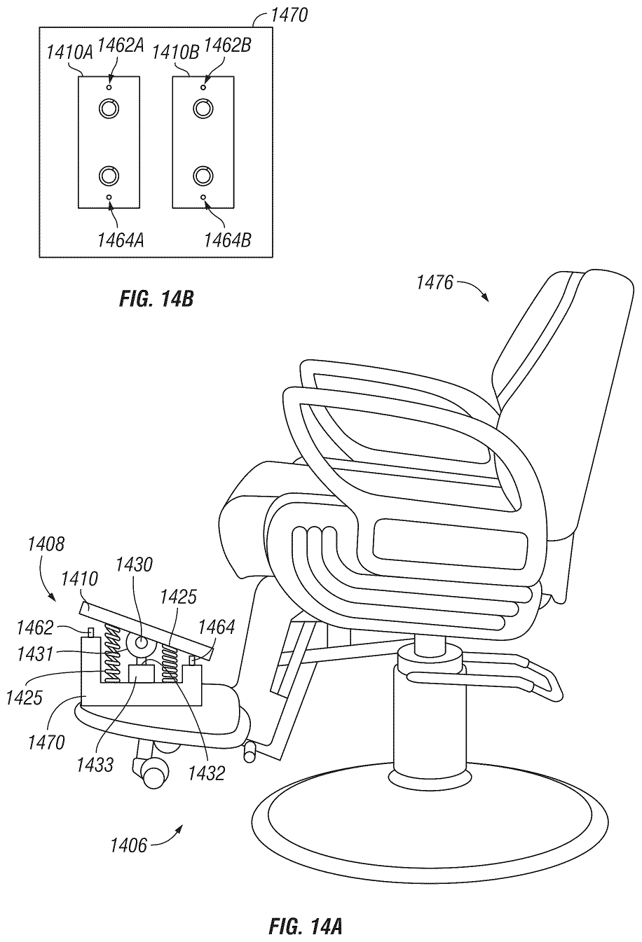

FIG. 13 illustrates a network interaction of the navigation controller apparatus. For example, the navigation controller apparatus may have a local computing device 1303 that can connect with a user interface or interaction apparatus and/or system 1304. In at least one embodiment, this connection may be between the navigation controller apparatus and a phone or other device capable of displaying and/or controlling aspects of the navigation controller apparatus. Additionally, the local computing device 1303 may connect through a network 1302 to a remote computing device 1301. The remote computing device 1301 may be a server. For example, the remote computing device 1301 may be a server for the game Fortnight™M that can then interact via the network 1302 with the local computing device 1303 and/or interacting apparatus and/or system 1304. In at least one example, the local computing device 1303 and/or interaction apparatus and/or system 1304 may have motors, and/or other actuators that can be activated by actions that occur from events stored and/or occurring on the remote computing device 1301. In at least one embodiment, the remote computing device 1301 may configure the local computing device 1303 and/or interacting apparatus and/or system 1304 through a wired or wireless network 1302.

Another example may have a user (not illustrated) running into a wall in a game running on the remote computing device 1301 and being displayed and/or interacted with by the interacting apparatus and/or system 1304 and/or the local computing device 1303 that may activate a motor or actuator when the user runs into the wall in the gaming environment to give tactile feedback of actions. Similarly, if the user is operating a motored device in the game, a motor on the navigation controller apparatus may also operate to give the user a simulated motion and/or vibration of actual movement. In some examples, the remote computing device 1301 may be a drone, robot, and/or other remote control vehicle or device, that is connected over a network 1302 to a local computing device 1303 to an interacting apparatus and/or system 1304 such as the navigation controller apparatus. In some examples, the local computing device 1303 may be a mobile or cellular phone. In other examples, the remote computing device 1301 may be an entertainment system and/or tablet coupled to a local computing device 1303 through a network 1302. In another example, the local computing device 1303 may be housed within the navigation controller apparatus and/or can be another computing device such as, but not limited to a cell phone, mobile phone, and/or tablet that can connect to a computing device housed within the interacting apparatus and/or system 1304. It would be understood that the remote computing device 1301 may include at least one computing device or at least one remote computing device. Additionally, the local computing device may include at least one computing device or at least one local computing device. The navigation controller apparatus, and/or system may be utilized for interactivity or with interactivity system such as gaming system, entertainment system, therapy system, arcade system, computing system, and/or virtual reality (VR) system.

FIG. 14A is an illustration of a chair mounted navigation controller 1400. The chair mounted navigation controller 1400 can include a navigation controller apparatus 1408 having footpad(s) 1410 coupled to a base 1470. In at least one embodiment, the base 1470 may be fixed to a portion of a chair 1476 that moves according to movements of the footpad(s) 1410 of the navigation controller apparatus 1408. As a user (not illustrated) operates the footpad(s) 1410 around an axle 1430, the movements may be captured and/or recorded with a magnet 1431, and Hall effect sensor 1432. The movement capture device (magnet 1431 and Hall effect sensor 1432) may include other electrical, light, wave, and/or magnetic fields that can be captured and/or recorded by a sensor that may be coupled to a computing device 1433. The movement capture device may capture and/or record the rotational movement and/or change of position of the footpad(s) 1410 within their range of motion.

In some embodiments, the footpad(s) 1410 may have sensors 1462 and/or 1464 that alert a computing device, such as the computing device 1433. In some embodiments, the computing device may be contained within and/or supported by the base 1470. In at least one example, the footpad(s) 1410 may also be supported by resistive devices 1425. The resistive devices 1425 may be adjustable, and in one embodiment may be springs. As a user (not illustrated) utilizes the navigation controller apparatus the resistance of the footpad 1410 movement may need to be modified to allow the user to increase their workout and/or therapy. This may be done via a computing device and/or user interface.

In at least one embodiment, the navigation controller apparatus 1408 may also be configured to operate as a mouse, gamepad, joystick, and/or certain keyboard actions for a computer and/or other computing device. This would allow a user (not illustrated) who has lost an arm or leg to utilize the navigation controller apparatus 1408 on the floor or a table in conjunction with a computer and/or computing device. The navigation controller apparatus 1408 can be used for therapeutic uses and may allow for a user to exercise each leg, foot, ankle, knees, and/or toes individually or collectively through different positioning and/or exercises. The independent and/or separated configuration of the footpad(s) 1410 allow for individual measurement and/or exercise of various limbs, muscles, tendons, and/or ligaments. Some of the motions and/or exercise the navigation controller apparatus may allow for are flexion, extension, pronation, supination, eversion, and inversion.

In at least one embodiment, as the chair 1476 rotates about the chair base 1480 in response to a user's engagement of the footpad(s) 1410 in a specific pattern. For example, much like the pattern illustrated in Table 1, a two footpad 1410A/1410B configuration as illustrated in FIG. 14B may allow for additional movement or locomotion movement interactions.

In FIG. 14B a first footpad 1410A, can interact with a left forward sensor 1462A, and a left rearward sensor 1464A. While a second footpad 1410B may interact with a right forward sensor 1462B, and a right rearward sensor 1464B. When a user (not illustrated) presses both footpads 1410A/1410B, the character in a virtual reality, immersive environment or other entertainment system or device such as but not limited to a video gaming system, video projection system, or other device or means of providing a user with entertainment value, would move forward or rotate forward. In an example where there are resistive device coupled to at least one resistive device sensor that allows for additional control of motion within the virtual reality or entertainment device. For example, the resistive device sensors could provide an indication of a forward movement, and the front sensors 1462A and/or 1462B could indicate when a user would like to rotate forward.

Conversely, when a user would like to move rearward or backwards, they could rotated both of the footpads 1410A/1410B rearward, engaging the rearward sensors 1464A/1464B. Similarly, in an example where there are resistive device coupled to at least one resistive device sensor that allows for additional control of motion within the virtual reality or entertainment device. For example, the resistive device sensors could provide an indication of a rearward movement, and the rear sensors 1464A and/or 1464B could indicate when a user would like to rotate rearward or backwards.

When a user moves the left footpad 1410A forward, and the right footpad 1410B rearward a character, avatar, or first person representation in a virtual reality, immersive environment or other entertainment system or device, could turn to the right. Conversely, when a user moves the left footpad 1410A rearward, and the right footpad 1410B forward a character, avatar, or first person representation in a virtual reality, immersive environment or other entertainment system or device, could turn to the left. In at least one embodiment, the chair 1476 may also rotate to the left or right based on the movement and/or engagement actions of the user with the footpad(s) 1410A and/or 1410B. Additionally, in at least one example, the forward sensors 1462A and/or 1462B, in combination with the rearward sensors 1464A and/or 1464B may also be used to cause rolls, and sidesteps of character, avatar, or first person representation in a virtual reality, immersive environment or other entertainment system or device. For example, when a user engages a left forward sensor 1462A, and a right rearward sensor 1464B the character, avatar, or first person representation in a virtual reality, immersive environment or other entertainment system or device, may roll or sidestep to the right. Conversely, a roll or sidestep to the left may occur with the engagement of a right forward sensor 1462B and a left rearward sensor 1464A. It would be understood that these descriptions of sensor, and footpad engagement are illustrative and could be configured within a gaming environment to a user's specific preferences.

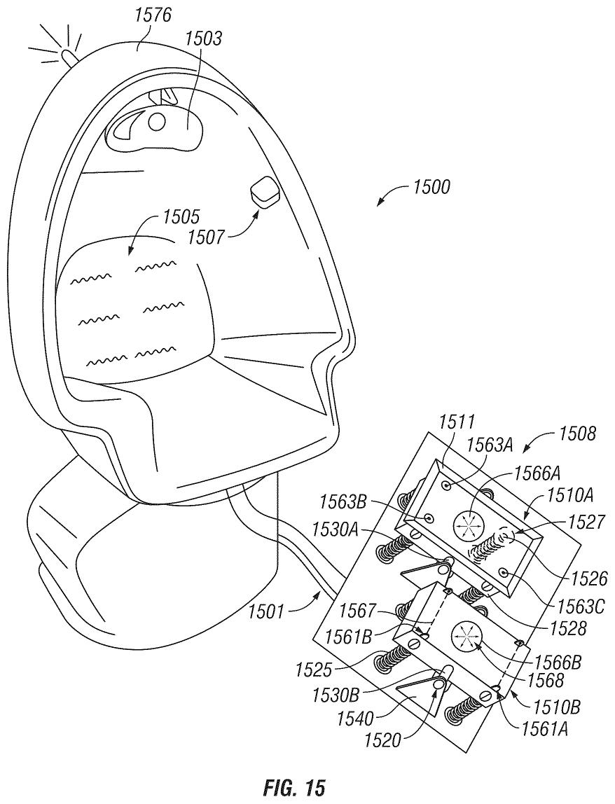

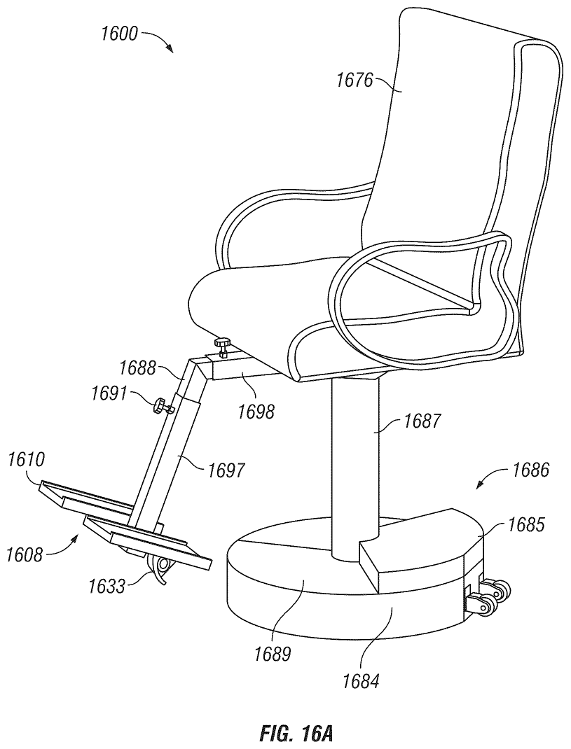

FIG. 15 is an illustration of a chair mounted navigation controller 1500. In at least one embodiment, the base 1570 of the navigation controller apparatus 1508 is coupled to a mount 1501 that couples on an opposing end to a chair 1576. This allows the navigation controller apparatus 1508 to move with any movements or rotations of the chair 1576.

In at least one example, the chair 1576 may allow for multi-axis movement and/or rotation. For example, the chair 1576 may allow for, including up to, a full 360 degrees of rotation about to a vertical axis (around a z-axis), and up to and including 180 degrees of rotation about a horizontal axis (both x and/or y). The chair 1576 may also allow for storage of headwear 1503, such as but not limited to, Virtual Realty glasses, helmet, headphones, or other headgear. In at least one example, the chair 1576 may also include sensory feedback through haptic or vibration systems 1505, smell and/or odor dispenser(s) 1507.

The navigation controller apparatus 1508 may include a first footpad 1510A and a second footpad 1510B (collectively 1510). The footpad(s) 1510 may have a lip 1511 to assist a user (not illustrated) in maintaining contact with the navigation controller apparatus 1508. In at least one embodiment, the lip 1511 may have sensor(s) along it and/or within it that can detect motion and/or other actions by a user that allow for interactions with the device. In at least one example, the footpad(s) 1510 can have sensors within and/or on their surface to allow for interactions. The sensors may include interactive or enablement sensors 1563A and/or 1563B, and/or 1563C, and/or detection sensors 1567, 1561A and/or 1561B.

In at least one example, the detection sensors 1561A and/or 1561B may be a beam interruption, range detection, pressure detection, or other sensors and/or circuits that would allow for a computing device to know when and/or how a user's foot (not illustrated) has interacted with the footpad(s) 1510. Similarly, the interaction and/or enablement sensors 1563A and/or 1563B, and/or 1563C can be switch(s), pressure detection, directional detection, and/or other sensors and/or circuits that would allow when and/or how an action is to occur. Additionally, the footpad(s) 1510 may also include a directional sensor 1566A and/or 1566B (collectively 1566). The directional sensor(s) 1566A and/or 1566B can allow a user (not illustrated) to indicate directional changes without having to remove their foot from the navigation controller apparatus 1508. For example, a user (not illustrated) that utilizes the navigation controller apparatus 1508 in a gaming environment may need to manipulate the viewing angle or direction of a character, the user could use their feet to cause the viewing angle to move by moving a directional sensor 1566A and/or 1566B without requiring a locomotion movement within the VR, gaming, entertainment or immersive environment. It would be understood that in one example, a locomotion movement may also cause a change in the viewing angle due to a change in a character's location, or facing direction, while the directional sensor(s) 1566 would allow for a change of viewing angle without changing the character's location, or facing direction. Additionally, the directional sensor(s) 1566 may be used to generate commands and/or movement of other elements such as alerions of remote control devices, control system for a remote control device, and/or robotic limbs for robotic devices. For example, a user may utilize the footpad(s) 1510 to actuate the up and/or down motions, and/or the rotational direction of the robot, like a fixed or mobile robot, while the directional sensor(s) 1566 can allow for the control of individual limbs of the robot as selected and/or commanded by the user (not illustrated) through interactions with the navigation controller apparatus and/or a local or remote computer system (not illustrated). In another example, a user may utilize the footpad(s) 1510 to control the movements of a fixed robot such as a manufacturing robot, or may utilize the footpad(s) 1510 to control the locomotion of a mobile robot.

In some examples a user may utilize both of the directional sensors 1566A and/or 1566B to manipulate two points of reference, for example, the viewing direction of a character and a map position of a character. In additional examples, the directional sensor(s) 1566 may act as a one or more keys on a keyboard. For example, a user may move a directional sensor 1566 in a first direction, and then move the footpad 1510 in a first direction, causing a secondary movement and/or reaction much like a user pressing a control key, and/or a letter key, and/or a directional or arrow key, or a combination or sequence of keys. In another example, when the directional sensor 1566 is neutral, footpad 1510 movement would trigger a movement in a virtual reality, remote computing system, and/or an entertainment system, but when the directional sensor 1566 is moved then movement of the footpad(s) 1566 may cause keyboard or mouse like actions to occur such as, but not limited to, a keyboard action for a mapped key, or a mouse click when the footpad 1510 is rotated in a specific direction in combination with a specific directional movement 1568 of the directional sensor 1566. Altogether the various positions of rotation of one or both directional sensor(s) 1566 may be detected and combined to determine an action or command. These actions or commands may be used to control a variety of activities within the virtual reality application such as adjusting a view (panning sideways or up or down, or zooming in or out), ascending or descending (while moving or not moving), jumping, swinging, controlling weapons or tools, opening doors, picking up items or interacting in any way. The motions of the directional sensor(s) 1566 could also be used to control a variety of movements and actions of a motor-driven device such as a robot, drone, wheelchair, or other remote control device. A movement or position change of the directional sensor(s) 1566 may be combined with a movement or position change of the one or both footpad(s) 1510 to trigger additional action or commands.

The navigation controller apparatus 1508 can include a first axle 1530A that can pass through and/or traverse at least a portion of the footpad 1510A, and/or a second axle 1530B that can pass through and/or traverse at least a portion of the footpad 1510B. In at least one example, the axle 1530A and/or 1530B may be visible through the stanchions 1540 at a pass through point 1520. The pass through point can allow the axis 1530A and/or 1530B to pass through the at least one stanchion 1540 to the footpad(s) 1510 or other connection points. Collectively, the axle(s) may be referred to as axle 1530. In at least one example, the footpad(s) 1510 may have an aperture through which the axle 1530 can pass allowing the footpad(s) to have at least one axis of rotational freedom. The axle 1530 may be supported by one or more stanchions 1540. The stanchions 1540 may be coupled to a base, or in some embodiments may be free standing to support the navigation controller apparatus 1508. The footpad(s) 1510, in at least one example, can be supported by one or more resistive devices 1525. In at least one embodiment, the one or more resistive devices are springs, and/or adjustable springs. The resistive devices 1525 may be adjustable through an opening and/or aperture 1528 of the footpad(s) 1510. The opening and/or aperture 1528 can also allow for adjustments to be made to the resistive devices 1525. For example, in at least one example, the resistive device 1525 may have a ball and/or sphere 1526 (or other geometric object) that is capable of being received by and/or within a detection receptacle 1527. The receptacle 1527 can be configured with a sensor to know when the ball and/or sphere 1526 has been received and/or when it has reached the maximum distance it can travel within the receptacle 1527. The combination of the ball and/or sphere 1526 and receptacle 1527 allows for the detection of when the footpad(s) 1510 have reached their maximum travel distance for that axis of freedom. In at least one example, the navigation controller apparatus 1508 may be seen by a computer system as a Human Interface Device (HID) using a standard or proprietary HID protocol in emulation of a joystick, gamepad, keyboard, and/or mouse. For example, a movement detected by the navigation controller apparatus would cause transmission of joystick movements to a display screen or system. For example, actuations and/or movements of the footpad(s) 1510A and/or 1510B may also trigger rotations of the chair 1576 in a forward or rearward rotation, a left, right, or sideways rotations, and/or a turning rotation about the base of the chair to allow a user to have the sensation of full freedom of movement during a VR, gaming, and/or immersive experience.

It would be understood that the navigation controller apparatuses of FIG. 14A, FIG. 14B, and/or FIG. 15 can be interchangeable. Additionally, the navigation controller movements, action, sensors, footpads, and/or other components, in at least one example, can be interchanged to meet a user's specifications.

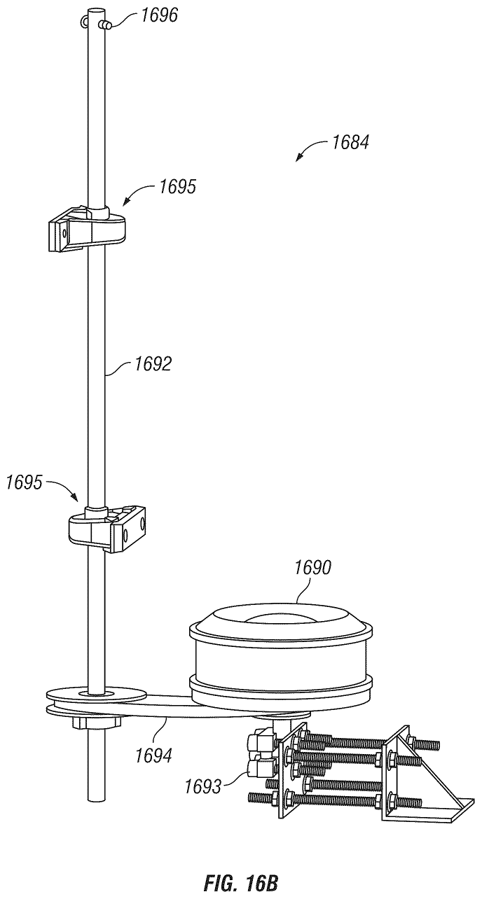

FIG. 16A is an illustration of a chair mounted navigation controller 1600. In at least one embodiment, the chair mounted navigation controller 1600 may include four assemblies: a base assembly 1686, a motor and transmission assembly 1684 partially housed within the base assembly 1686, a navigation controller assembly 1608, and a navigation controller support assembly 1688. The four assemblies, in at least one example, may allow for a chair 1676 or a chair seat to be attached to the base assembly 1686 or central column 1687. This can allow a user to utilize their favorite chair or cushion with the chair mounted navigation controller 1600.

The base assembly 1686 can be configured to have an outer diameter that provides a sufficient contact with a stable structure such as but not limited to a floor, and a sufficient enough mass to reduce the possibility of the chair mounted navigation controller 1600 from tipping over. In at least one example, the chair mounted navigation controller 1600 may have a base assembly 1686 with a diameter of about 61 cm (24 in) and a mass of about 22.5 kg (50 lb). It would be understood that about can include any amount that is plus or minus ten percent of the amount or range provided. The base assembly 1686 can include at least one top plate 1689 to cover the interior of the base assembly 1686, a central column 1687 that can allow for the connecting of the base assembly 1686 to the chair 1676. In at least one example, a gusset 1685 may be coupled to the top of the top plate 1689 to secure the central column 1687 to the base assembly 1686. A gusset 1685 may be made from plastics, wood, metal, composite, synthetics, or combinations thereof along with the base assembly and the central column. The connection between the central column 1687 and the chair 1676 may be made via a column plate or a ball-bearing turntable that enables the base assembly 1686 to remain stationary while the chair 1676 rotates. In some examples, the base assembly 1686 may include three gussets 1685 that are coupled to the top of the top plates 1689 at intervals of 120-degrees. Further, the base assembly 1686 may be configured to have a flat sidewall having outlets configured to connect the chair mounted navigation controller 1600 to a computing device and/or an external power source via a cable. In at least one example, the computing device is connected to the chair mounted navigation controller 1600 via a wireless connection. Additionally, the flat sidewall can include castor wheels to aid in the transportation of the chair mounted navigation controller 1600. The motor and transmission assembly 1684 can be configured to provide a torque to the chair 1676 allowing it to rotate according to a user's inputs to the chair mounted navigation controller 1600.

Referring to FIG. 16B that is an illustration of the motor and transmission assembly 1684, in at least one embodiment the motor 1690 is connected to an adjustable mount 1693 to accommodate a coupling of the transmission assembly and motor 1684 to the chair 1676. In at least one example, the motor 1690 is connected to the adjustable mount 1693 or transmission system to provide a tension for a belt 1694. A rotary shaft 1692 can be coupled to a pulley on the motor 1690 via the belt, which enables the motor 1690 to transmit the torque through the rotary shaft 1692 and to the chair 1676. In some examples, the belt may be a friction belt, which enables a quieter and simpler design than a toothed belt or a chain drive. In other examples, the belt may be replaced by a set of gears, or a combination of gears and belts, or other mechanical coupling configured to transfer power from one point to a second point. The rotary shaft 1692 may optionally include bearings 1695, which in at least one example can be collared bearings, to reduce stress on the shaft to within tolerable levels. In at least one example, the rotary shaft 1692 may include at least two collared bearings having a diameter of about 1.2 cm (0.5 in) to accommodate a slip ring for signal transmission. The slip ring can allow for wired connections to pass along the shaft without tangling or wrapping. A first collared bearing 1695 may be mounted to the base plate while the second and third collared bearings are positioned at higher positions on the rotary shaft via bearing mounts affixed to the central column. The top of the rotary shaft comprises a pin 1696 that couples the rotary shaft 1692 to a junction on the bottom of the chair 1676 (shown in FIG. 16A), which enables the torque to be transmitted to the chair 1676. In other examples, a direct-drive turntable assembly may be attached directly to the underside of the seat. Rotation of the chair by means of the motor and transmission assembly or turntable assembly is controlled by a computing device which receives signals from the virtual reality system via wired or wireless communication.

With reference to FIGS. 16A and 16B, the navigation controller support assembly 1688 may include at least one telescoping tubing element 1697, a seat junction (not shown), and at least one adjustable knob 1691. The navigation controller support assembly 1688 may be configured to be adjustable in size so as to accommodate users of various sizes. The upper part 1698 of the navigation controller support assembly 1688 is connected to the seat junction, which is connected to the rotary shaft 1692 via the pin 1696. The pin 1696 is configured to lock the navigation controller support assembly 1688 and the motor and transmission assembly 1684 together. The pin 1696 may be accessible through a removable plug. The seat junction is configured to mount both the turntable and the seat 1676. Wires may be positioned to enter through a hole in the bottom of the seat junction and through an opening of the navigation controller support assembly 1688. The navigation controller support assembly 1688 is configured to withstand force applied by a user and to accommodate the necessary wiring to transmit signals from the navigation controller support assembly 1688 to the various computing devices in the chair mounted navigation controller 1600. In at least one embodiment, a navigation controller assembly 1608 may include a first footpad 1610A and second footpad 1610B are attached to a mounting bar 1697 which may be fixed to a portion of a chair 1676. The footpad(s) may include one or more return springs that allow for the footpad(s) to be returned to a neutral position after movement. Additionally, each footpad may be moved independent of one another through a rotatable axels or set of axels where such movements are captured and/or recorded with a sensor 1633 that may be coupled to a computing device. The computing device can be located either in the foot controller subassembly or elsewhere in the assembly with wired or wireless communication to the virtual reality system.

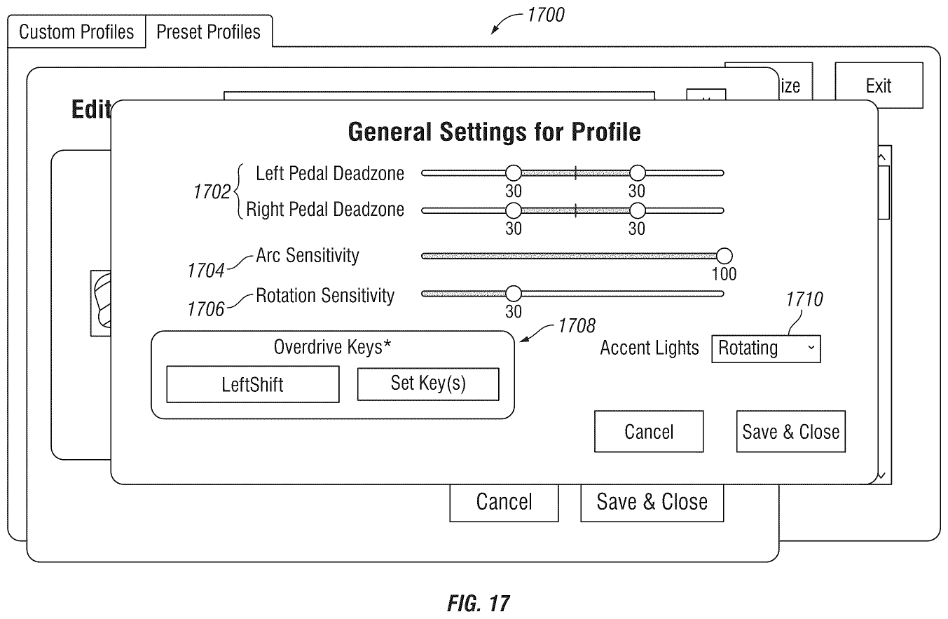

FIG. 17 is an illustration of a screenshot for the configurator 1700. The configurator 1700 can enable the user to define parameters related to sensitivity 1704, 1706, overdrives 1708, lighting 1710, and dead zone 1702. In at least one embodiment, the chair mounted navigation controller 1600 or any of the navigation controllers or virtual reality locomotion apparatuses or systems of the present disclosure may utilize a configurator 1700 to define operating parameters for the navigation controller assembly 1608 of FIG. 16A, sensors, computing devices, switches or other components that allow for some aspect of control or communication.

For example, the user can specify the amount of dead zone 1702 in each individual pedal and the sensitivity of the arc 1704 and rotation 1706 of the chair 1676. Adjusting the dead zones 1702 of the pedals enables the user to account for hardware inconsistencies in the sensors, which may otherwise not function as originally manufactured. Similarly, adjusting the sensitivities 1704, 1706 is critical as different users may apply differing amounts of force to the navigation controller assembly or footpads and react differently to the feedback of the applied force.

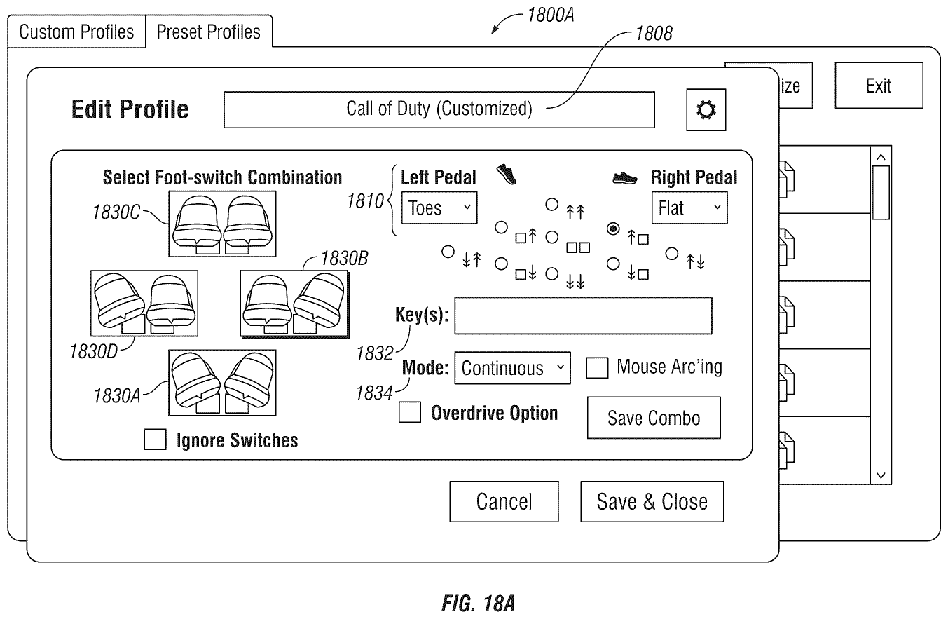

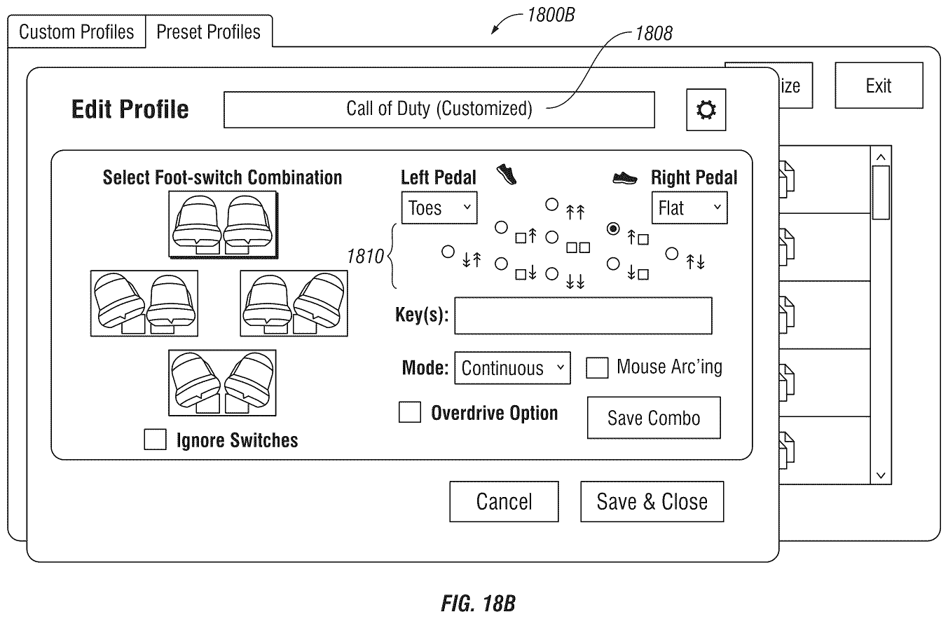

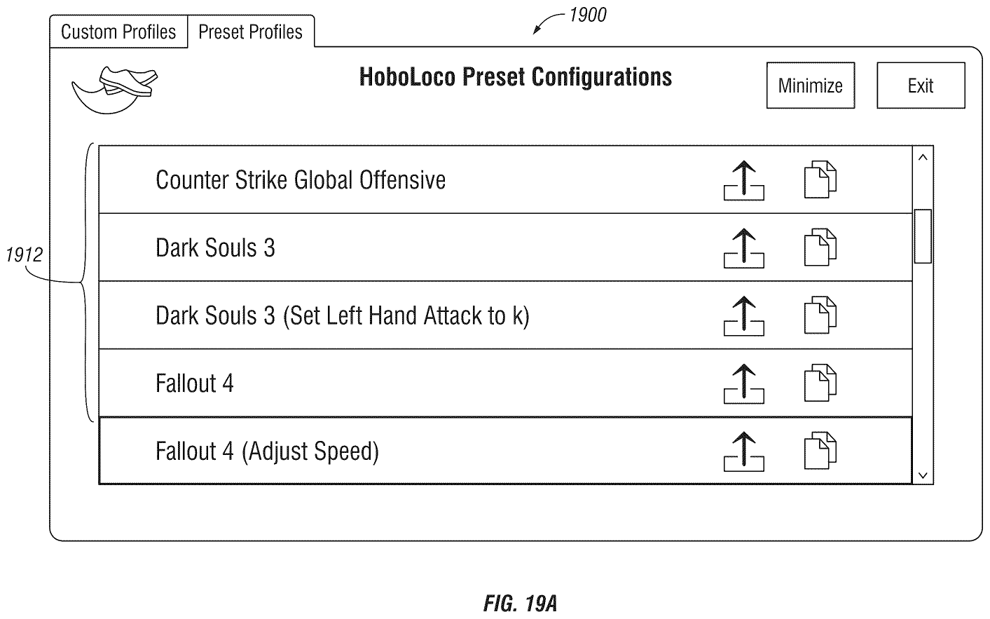

FIG. 18A is a screenshot illustration of a configurator 1800A with a first switch and pedal configuration. FIG. 18B is a screenshot illustration of a configurator 1800B with a second switch and pedal configuration. With reference to FIGS. 18A and 18B the configurator 1800A/1800B enables the user to select and modify a set of controller inputs for each of the positions and movements 1810 of the navigation controller assembly, locomotion device, or other footpad(s) allowing them to be used with specific games 1808. In at least one example, the user may prefer to move in a 30 degree angle from the direction he/she is facing rather than straight forward. Such configurations enable users to customize the operation of the chair mounted navigation controller 1600 or any of the navigation controllers for maximum benefit in each game. For example, a user who has no ability to use a hand controller at all may create a very complex configuration which supplants the normal hand control functions while another may choose to create a simple navigation only configuration which augments hand controls. Similarly, users may choose to start with large dead zones and lower sensitivity settings and subsequently decrease the dead zones and adjust the sensitivity as they become more experienced. Users may find that the sensitivity of some games is innately higher than others.

For example, a user may select the pedal position from the toes, heel or neutral, along with other sensor selections such as a movement plate or foot placement sensor. Based on the specified positioning 1810 and switch selection 1830A/1830B/1830C/1830D, a specified combination of corresponding keys 1832 for a keyboard are also selected, along with the type of key action 1834, such as but not limited to single or double click or continues press. A user may cause the inversion or eversion of their foot (feet) to trigger one or more switches on the footpad(s). This can allow for additional combinations or key selections. For example, the configurator 1800A is a combination of a right footswitch and pedal position of toe position of the left foot (pedal) and flat position for the right foot (pedal) that provided for a continuous “AW” key press as if a user was pressing that combination of keys on a keyboard. Further examples, the configurator 1800B is a combination of no footswitches and pedal position of toe position of the left foot (pedal) and flat position for the right foot (pedal) that provided for a continuous “R” key press as if a user was pressing that combination of keys on a keyboard.

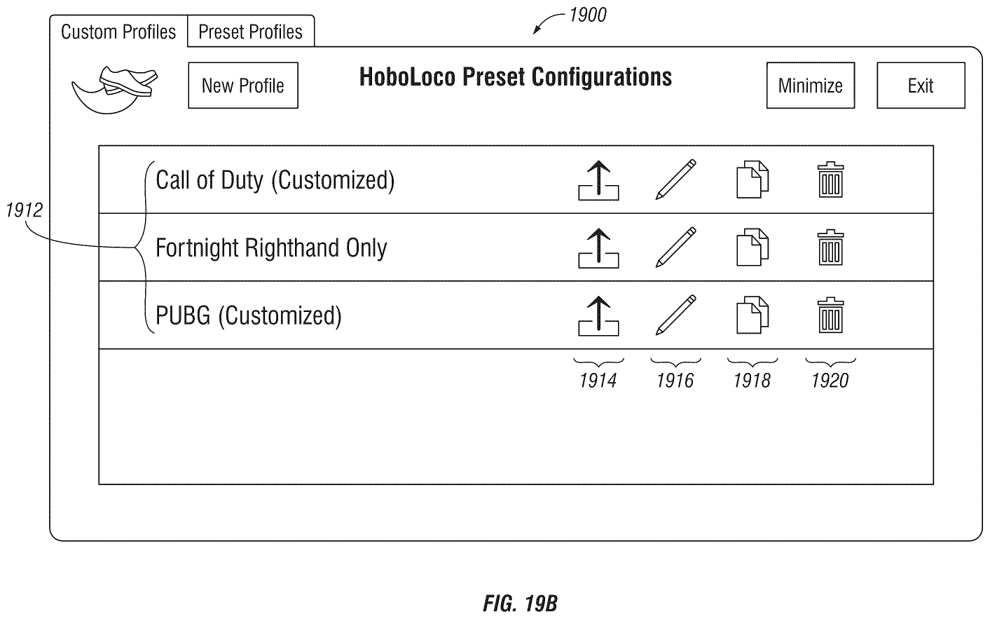

As illustrated in FIG. 19A, the user may utilize the configurator 1900 to save each customized configuration 1912, and may even generate multiple customized configurations for a particular game. Additionally, as illustrated in FIG. 19B, the user may share 1914, edit 1916, copy 1918, or delete 1920 the customized configurations for particular games.

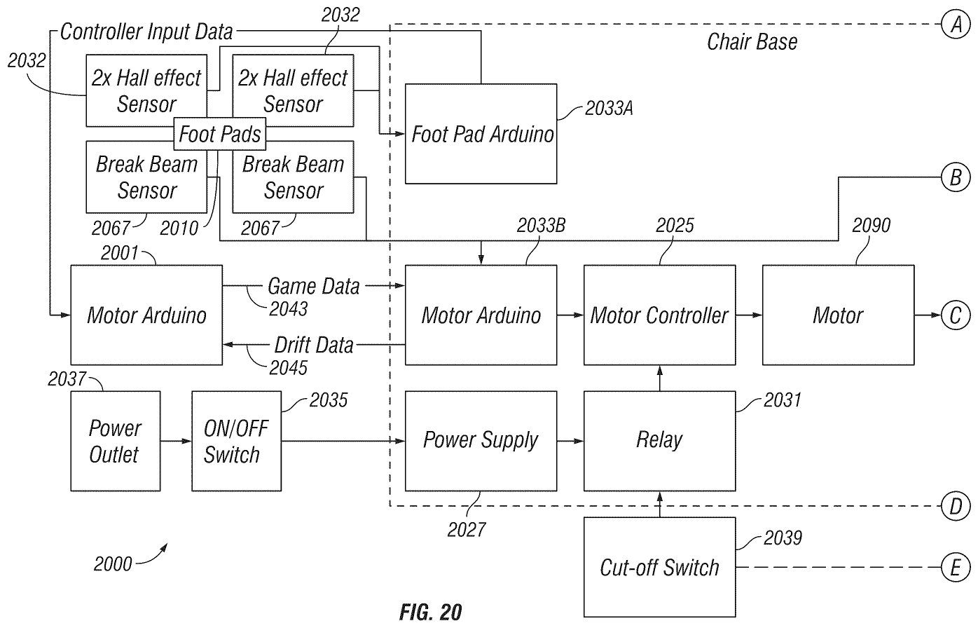

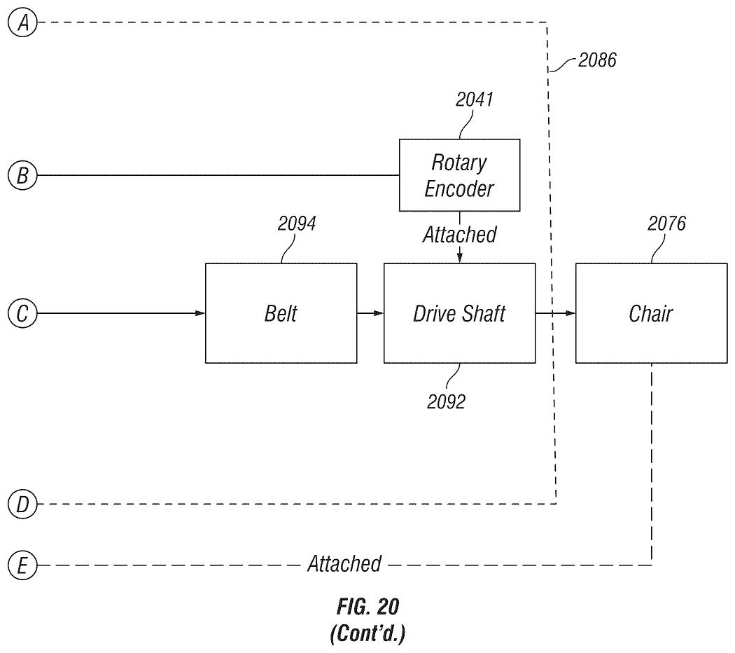

FIG. 20 is a block diagram illustration of a chair mounted navigation controller 2000. The chair mounted navigation controller 2000 can include a set of independently movable footpads 2010 coupled to a chair 2076, and/or a base assembly 2086. The footpads 2010 can include, in at least one example, detection sensors 2067. The sensors 2067 may be line break sensors, pressure sensors, or other object or touch detection sensors. The footpads 2010 may also be coupled to a magnet that may allow the movement of the footpad(s) 2010 to be detected by a sensor 2032. The sensor 2032, in at least one embodiment, is a Hall effect sensor. In some embodiments, the magnet may alternatively be a light source, or some other electric or magnetic field emitting device or element that can be monitored by the sensor 2032. The sensor 2032 may be coupled to a computing device 2033A. The computing device 2033A may connect to a display or interface device (not illustrated) that is configured to receive information from the navigation controller apparatus 2000.

In at least one embodiment, the computing device 2033 can be coupled to a motor 2090 that allows for movement of the chair 2076 about an axis passing through the base assembly 2086. The axis may be aligned with a drive shaft 2092 that allows for rotation when the motor 2090 causes a rotate via a belt 2094, gears, or other mechanical engagement mechanisms. The motor 2090 may receive signals from a first computing device 2033A, a second computing device 2033B, and/or a motor controller 2025. In at least one example, the first computing device 2033A may be coupled to the footpads 2010 that allow for detections of movement that may include movements for a mouse or other computer interface system. The motor controller 2025 may be coupled to a power source 2027 through one or more electrical elements, conditioning, or connection systems. The electrical elements, condition, or connection systems may include a relay 2031, a power switch 2035, a power cable or outlet connection 2037, or an emergency switch 2039. In at least one example, the emergency switch 2039 can allow a user to push a button or switch coupled or connected to the chair 2076 to prevent the movement of the chair 2076. In some examples, the emergency switch 2039 may be a pressure switch or weight activated switch.

The first computing device 2033A or second computing device 2033B may also couple to a rotary encoder 2041 that allows for detection or measurement of the movement of the chair 2076 about the axis, by measuring the rotation or rotational angle of the drive shaft 2092. The computing devices 2033A/2033B may also couple to a remote computing device 2001 such as a Virtual Reality (VR), Alternative or Augmented Reality (AR), PC, gaming console, or other gaming or computing device. These computing devices may send game or visual data 2043 or movement data 2045 between one another. For example, the footpads 2010 may be utilized to generate mouse or mouse like movement based on a configuration profiles chosen by a user. This could be advantageous for those having injuries or paralysis of the upper body. Alternatively, the navigation controller may be placed on a table or other holding device to allow those with hand injuries or lower body paralysis to manipulate games, computers, or other devices in a manner similar to a mouse or joystick.

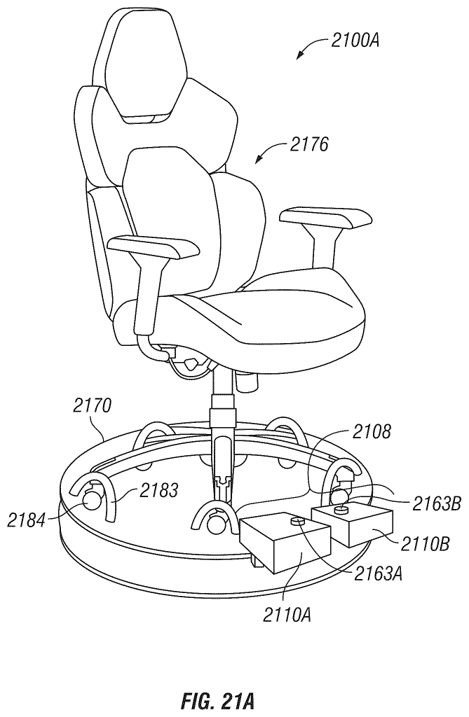

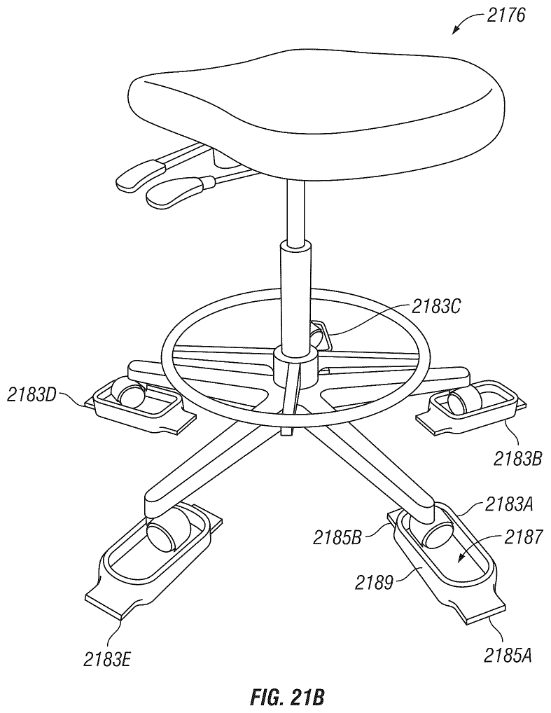

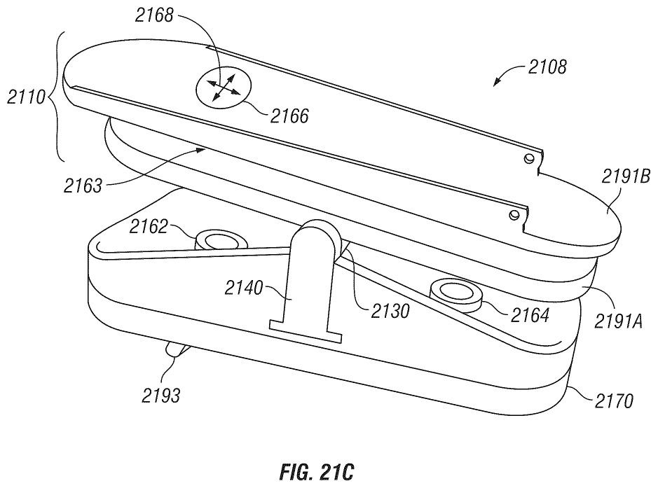

FIG. 21A is an illustration of a navigation controller chair system 2100A, having a navigation controller apparatus 2108 and rotating platform 2170 configured to receive a chair 2176. In at least one embodiment, the rotating platform 2170 may be coupled to a portion of a chair 2176, and the rotating platform 2170 moves according to movements of the footpad(s) 2110A/2110B of the navigation controller apparatus 2108. In some examples, the rotating platform 2170 may include a base or be coupled to a floor or other non-movable surface. As a user (not illustrated) operates the footpad(s) 2110A/2110B, the movements may be captured and/or recorded. In some examples, the movement capture or recording may occur through the use of devices such as, but not limited to, magnets and Hall effect sensors, but may include other devices that generate electrical, light, wave, and/or magnetic fields that can be captured and/or recorded by a sensor that may be coupled to a computing device. The movement capture device may capture and/or record the rotational movement and/or change of position of the footpad(s) 2110A/2110B within their range of motion.

The rotating platform 2170 may have indentions or securing mechanisms 2183 that allow for the chair 2176 to be secured to the rotating platform 2170. In at least one example, the chair 2176 may have rollers or wheels 2184 that can be engaged with the indentions or securing mechanisms 2183. The chair 2176 can be a standard office chair or gaming chair in order to allow more users to have access to the features of the navigation controller 2100. The navigation controller chair system 2100A can have a navigation controller apparatus 2108 with one or more footpad(s) 2110A/2110B, with each foot pad having a switch or other engageable mechanism 2163A/2163B. Similarly, the interaction and/or enablement sensors 2163A/2163B, can be switch(es), pressure detection, directional detection, and other sensors and/or circuits that would allow the navigation controller apparatus 2108 to know when and/or how an action is to occur. In some examples, the chair 2176 may have multiple wheels, legs, and/or feet that may engage with a set of securing mechanisms 2183. In other examples, the chair may be a stool or other device that allows a user to be seated or resting against and be affixed in a permanent or semi-permanent manner to the rotating platform. The securing mechanisms 2183 may allow for the rotation of the rotating platform 2170 through mechanical means such as motors, solenoids, or other movement devices, without placing the user in a position that requires movement in a compromised environment. For example, a user wearing googles would not want to be moving in a manner that would allow them to leave the platform with their eyesight impaired.

In at least one embodiment, the securing mechanisms 2183 can allow for the chair 2176 to be secured to the rotating platform 2170 while a user utilizes the navigation controller apparatus 2108 to engage and/or interact with a computing device, gaming device, VR device, or AR device (not illustrated). It would be understood that the navigation controller apparatus 2108, rotating platform 2170, and/or footpad(s) 2110A/2110B could utilize features of any navigation controller or foot pad(s) presented herein. The interactions with the switch or other engageable mechanism 2163A/2163B may cause the rotation of the platform 2170 and/or the user.

In at least one embodiment, the navigation controller apparatus 2108 may also be configured to operate as a mouse, gamepad, joystick, and/or certain keyboard actions for a computer and/or other computing device. This would allow a user (not illustrated) who has lost an arm or leg to utilize the navigation controller apparatus 2108 on the floor or a table in conjunction with a computer and/or computing device. The navigation controller apparatus 2108 can be used for therapeutic uses and may allow for a user to exercise each leg, foot, ankle, knees, and/or toes individually or collectively through different positioning and/or exercises. The independent and/or separated configuration of the footpad(s) 2110A/2110B allow for individual measurement and/or exercise of various limbs, muscles, tendons, and/or ligaments. Some of the motions and/or exercise the navigation controller apparatus may allow for are flexion, extension, pronation, supination, eversion, and inversion.

FIG. 21B is an illustration of a chair 2176 engaged with a set of securing mechanism(s) 2183A, 2183B, 2183C, 2183D, and/or 2183E (collectively securing mechanisms 2183). The chair 2176 can be any type of office, gaming, dining, or other types of chairs that utilize legs and wheels and/or feet to interact or engage with a floor or surface. The feet or wheels of the chair 2176 can engage with the securing mechanisms 2183 to secure or prevent the independent movement of the chair from a platform or surface.

In at least one example, the securing mechanisms 2183 may have a set of engagement points 2185A and 2185B that allow for the positioning of the securing mechanisms 2183 about a surface or platform. The engagement points 2185A/2185B may be configured in many different shapes or sizes to allow different chairs to be utilized with a surface or platform. Additionally, in at least one example, the securing mechanisms 2183 can have an engagement surface 2187. In some examples, the engagement surface 2187 may have a ramped or variable surface that can assist in the prevention of feet or wheel movement of the chair 2176.

The engagement surface 2187 may be surrounded by a set of retaining wall(s) 2189. The set of retaining wall(s) 2189 may be found on one or more sides of the engagement surface 2187. For example, the set of retaining wall(s) 2189 may be four vertical walls on the four edges of a rectangular engagement surface 2187 that is substantially horizontal. Substantially horizontal would be considered any change of less than 20 degrees from the horizontal zero point. In other examples, the variability of the engagement surface 2187 may negate the advantage of a retaining wall on one side, and thus allow for the retaining wall(s) 2189 to be seen on three sides of the engagement surface 2187. In some embodiments, the engagement surface 2187 may be formed by a depression in the upper side of platform 2170.

FIG. 21C is an illustration of a navigation controller apparatus 2108. The navigation controller apparatus 2108 can allow for the movement of a set of footpads (shown as a single footpad 2110 based on the illustrated view, it would be understood that two would be utilized in at least one embodiment). The footpad 2110 can move about an axel 2130, or in some examples a rotational point. The axel 2130 may be configured to engage with a stanchion 2140 or other interaction point.

In at least one example the axle 2130 is disposed on a stanchion 2140 that serves to support the axle 2130 and allows the user to interact with the navigation controller apparatus 2108. The manner in which the axle 2130 passes through and supported by the stanchion 2140 is dictated by the connection means between the axle 2130 and the stanchion 2140. For example, the stanchion 2140 can comprise a mount upon which the axle sits and rotates. The connection between the axle 2130 and the stanchion 2140 can use any other currently available or later developed technology for connecting the two components.

The present disclosure illustrates a stanchion 2140 disposed outside the footpads. However, in other embodiments, more than one stanchion can be used to support the weight of the users, and/or the activities of a user, and the stanchions can comprise any arrangement to support the axle 2130 and the navigation controller apparatus 2108. For example, a stanchion can be placed on each end of or on the underside of the navigation controller apparatus 2108 instead of between the footpads 2110. Such stanchion arrangement can provide more support to the apparatus 2100 when a user stands on the navigation controller apparatus 2108. Further, the stanchion 2140 can have any shape to accommodate supporting the axle 2130 and the footpads 2110.

In at least one embodiment, the navigation controller apparatus 2108 can include a first axle 2130 that can pass through and/or traverse at least a portion of the footpad 2110, and/or a second axle (illustrated in FIG. 15) that can pass through and/or traverse at least a portion of a second footpad. In at least one example, the axle 2130 may be visible through the stanchions 2140 at a pass through point. The pass through point can allow the axel 2130 to pass through the at least one stanchion 2140 to the footpad(s) 2110 or other connection points. Collectively, the axle(s) may be referred to as axle 2130. In at least one example, the footpad(s) 2110 may have an aperture through which the axle 2130 can pass allowing the footpad(s) to have at least one axis of rotational freedom. The axle 2130 may be supported by one or more stanchions 2140. The stanchions 2140 may be coupled to a base, or in some embodiments may be free standing to support the navigation controller apparatus 2108. The footpad(s) 2110, in at least one example, can be supported by one or more resistive devices. In at least one example, the one or more resistive devices are springs, and/or adjustable springs as seen in FIG. 15. For example, in at least one example, the resistive device may have a ball and/or sphere (or other geometric object) that is capable of being received by and/or within a detection receptacle 2162 and/or sensor 2164. The receptacle 2162 can be configured with a sensor to know when the ball and/or sphere has been received and/or when it has reached the maximum distance it can travel within the receptacle 2162. The combination of the ball and/or sphere and receptacle 2162 allows for the detection of when the footpad(s) 2110 have reached their maximum travel distance for that axis of freedom. In at least one example, the navigation controller apparatus 2108 may be seen by a computer system as a Human Interface Device (HID) using a standard or proprietary HID protocol in emulation of a joystick, gamepad, keyboard, and/or mouse. For example, a movement detected by the navigation controller apparatus would cause transmission of joystick movements to a display screen or system. For example, actuations and/or movements of the footpad(s) 2110 may also trigger rotations of the chair 2176 in a forward or rearward rotation, a left, right, or sideways rotations, and/or a turning rotation about the base of the chair to allow a user to have the sensation of full freedom of movement during a VR, gaming, and/or immersive experience.

In some examples, a force or means of force such as springs, motors, strain gauges, solenoids, or other means of force or force detection may be utilized as footpad support (not illustrated). In one embodiment, the springs themselves can be sensors via being piezo-electric, and any force exerted on them can be transformed into an electrical signal that can be interpreted by a processor or a computing device. The force or means of force call allow for the footpad(s) 2110 to be returned to a neutral, original, or first position after being moved by a user. For example, a user may use a pitch (forward or backward) movement about an axel or neutral position. In another example, the footpad(s) 2110 may be rolled or yawed about a different axis passing through the navigation controller apparatus 2108. Pitch would be considered a forward or backward (toe or heel up or down) movement, roll would be a left or right movement (lean left or lean right), and yaw would be a twisting motion (toe in—heel out, or toe out—heel in) movement. These types of movements can allow the navigation controller apparatus 2108 to be utilized individually or in combination with a rotating platform to allow a user to interact with a head mounted display system or a teleoperation system. For example, a head mounted display system may be a Virtual Reality, Mixed Reality, or Augmented Reality headset or goggle system, and a teleoperation system may be a remote control system for vehicles, aircrafts, drones, autonomous system, or any other device capable of operating on land, sea, air, or space. The navigation controller apparatus 2108 may have a computing device housed within it or be coupled to a computing device operated by the user, in close proximity to the navigation controller apparatus 2108. For example, close proximity could be within a wireless single connection range such as, but not limited to, WiFi or Bluetooth.

The footpad 2110 may have a first surface 2191A, and a second surface 2191B that are removably engaged with one another that allows the second surface 2191B to move independently of the first surface 2191A in at least one direction. A switch or user interactivity point 2163 can allow for various activities or actions to be activated by a user. Similarly, the second surface 2191B may allow for a freedom of movement 2166, in a plurality of direction 2168 in relation to the first surface 2191A and/or the navigation controller apparatus 2108. For example, when the second footpad surface 2191B is engaged and/or interacted with, the second footpad surface 2191B may move in relation to the first footpad surface 2191A thus allowing a movement or action to be recorded and/or captured by the navigation controller apparatus 2108. In some examples, the movement or action will not be recorded and/or captured unless a user activates an interaction and/or enablement sensors 2163 affixed between the first footpad surface 2191A and the second footpad surface 2191B. The interaction and/or enablement sensor(s) 2163 can allow in at least one example for the detection of roll or yaw of the footpads 2110, or through other sensor or detection systems. The detection of these control signals or operations can allow both fully capable users as well as users with upper limb differences and disabilities to take advantage of the dual footpad navigation controller apparatus. While it would also be understood that the dual footpad design could also be utilized with other limbs of a user.

Additionally, the footpad(s) 2110 may also include a directional sensor 2166. The directional sensor(s) 2166 can allow a user (not illustrated) to indicate directional changes without having to remove their foot from the navigation controller apparatus 2108. For example, a user (not illustrated) that utilizes the navigation controller apparatus in a gaming environment may need to manipulate the viewing angle or direction of a character, the user could use their feet to cause the viewing angle to move by moving a directional sensor 2166 without requiring a locomotion movement within the VR and/or gaming environment. It would be understood that in one example, a locomotion movement may also cause a change in the viewing angle due to a change in a character's location, or facing direction, while the directional sensor(s) 2166 would allow for a change of viewing angle without changing the character's location or facing direction. Additionally, the directional sensor(s) 2166 may be used to generate commands and/or movement of other elements such as alerions of remote control devices, control system for a remote control device, and/or robotic limbs for robotic devices. For example, a user may utilize the footpad(s) 2110 to actuate the up and/or down motions, and/or the rotational direction of the robot, like a fixed or mobile robot, while the directional sensor(s) 2166 can allow for the control of individual limbs of the robot as selected and/or commanded by the user (not illustrated) through interactions with the navigation controller apparatus and/or a local or remote computer system (not illustrated). In another example, a user may utilize the footpad(s) 2110 to control the movements of a fixed robot, such as a manufacturing robot, or may utilize the footpad(s) 2110 to control the locomotion of a mobile robot or drone.

In some examples a user may utilize multiple directional sensors 2166 to manipulate two points of reference, for example, the viewing direction of a character and a map position of a character. In additional examples, the directional sensor(s) 2166 may act as one or more keys on a keyboard. For example, a user may move a directional sensor 2166 in a first direction, and then move the footpad 2110 in a first direction, causing a secondary movement and/or reaction much like a user pressing a control key and/or a letter key and/or a directional or arrow key, or a combination or sequence of keys. In another example, when the directional sensor 2166 is neutral, footpad 2110 movement would trigger a movement in a virtual reality, remote computing system, and/or an entertainment system, but when the directional sensor 2166 is moved then movement of the footpad(s) 2110 may cause keyboard or mouse like actions to occur such as, but not limited to, a keyboard action for a mapped key, or a mouse click when the footpad 2110 is rotated in a specific direction in combination with a specific directional movement 2168 of the directional sensor 2166. Altogether the various positions of rotation of one or both directional sensor(s) 2166 may be detected and combined to determine an action or command. These actions or commands may be used to control a variety of activities within the virtual reality application such as adjusting a view (panning sideways or up or down, or zooming in or out), ascending or descending (while moving or not moving), jumping, swinging, controlling weapons or tools, opening doors, picking up items or interacting in any way. The motions of the directional sensor(s) 2166 could also be used to control a variety of movements and actions of a motor-driven device such as a robot, drone, wheelchair, or other remote control device. A movement or position change of the directional sensor(s) 2166 may be combined with a movement or position change of the one or both footpad(s) 2110 to trigger additional action or commands.

A retention point 2193 may also be utilized to prevent the navigation controller apparatus 2108 from moving on a surface or platform. In at least one example, the retention point 2193 may also allow for the angle and/or height of the navigation controller apparatus 2108 to be adjusted.

Additionally, it is understood that a browser or program could be implemented on a mobile device, such as, a phone, a mobile phone, a cell phone, a computer, a tablet, a laptop, a mobile computer, a personal digital assistant (“PDA”), a processor, a microprocessor, a micro controller, or other devices or electronic systems capable of connecting to a user interface and/or display system such as a computing device.

The present disclosure may also comprise a computing device that can include any of an application specific integrated circuit (ASIC), a microprocessor, a microcontroller, a digital signal processor (DSP), a field-programmable gate array (FPGA), or equivalent discrete or integrated logic circuitry such as but not limited to a Central Processing Unit. In at least one embodiment, the central processor unit could include an ASIC, microprocessor, microcontroller, DSP, FPGA, or other discrete or integrated logic circuits. In some examples, the system may include multiple components, such as any combination of one or more microprocessors, one or more microcontrollers, one or more DSPs, one or more ASICs, or one or more FPGAs. It would also be understood that multiples of the circuits, processors, or controllers could be used in combination or in tandem, or multithreading.

The components of the present disclosure may include any discrete and/or integrated electronic circuit components that implement analog and/or digital circuits capable of producing the functions attributed to the systems, methods, or modules herein. For example, the components may include analog circuits, e.g., amplification circuits, filtering circuits, and/or other signal conditioning circuits. The components may also include digital circuits, e.g., combinational or sequential logic circuits, memory devices, etc. Furthermore, the modules may comprise memory and/or storage devices that may include computer-readable instructions that, when executed cause the modules to perform various functions attributed to the modules herein.

Memory may include any volatile, non-volatile, magnetic, or electrical media, such as a random access memory (RAM), dynamic random access memory (DRAM), static random access memory (SRAM), read-only memory (ROM), non-volatile RAM (NVRAM), electrically-erasable programmable ROM (EEPROM), flash memory, hard disks, or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, solid state medium, or any other number of possible drives or discs, that are executed by the internal logic of a computing device. It would be understood that the tangible non-transitory computer readable medium could also be considered a form of memory, storage device, or storage media.

Other embodiments of the locomotion apparatus may be used to navigate drones, robots, or other types of device requiring locomotion and navigation. These embodiments may be used with an augmented reality system, or any other type of currently available or later developed system for viewing or simulating an environment.

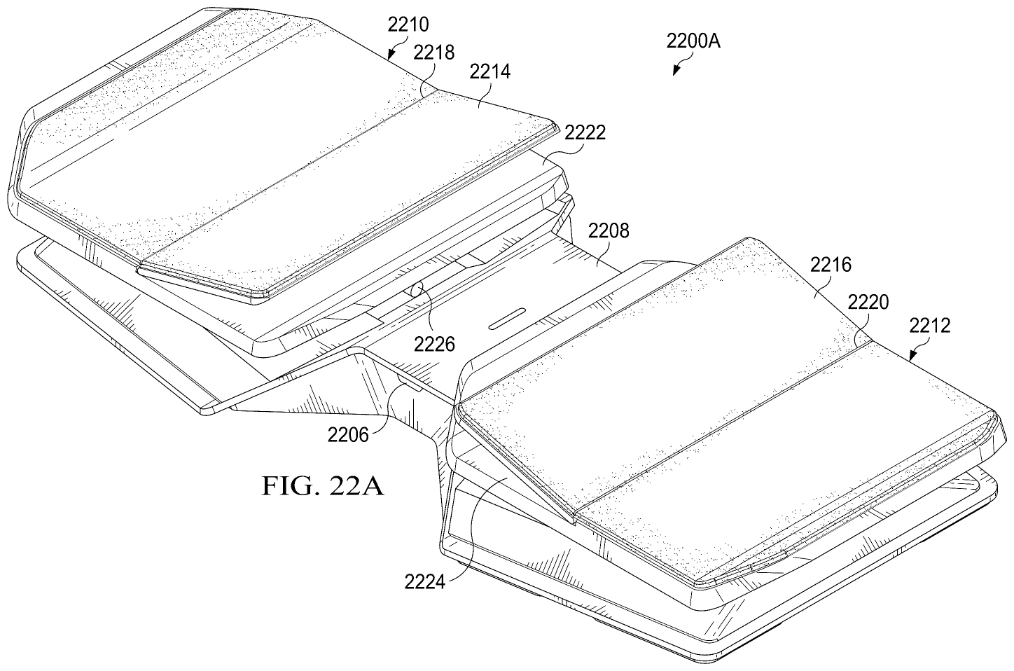

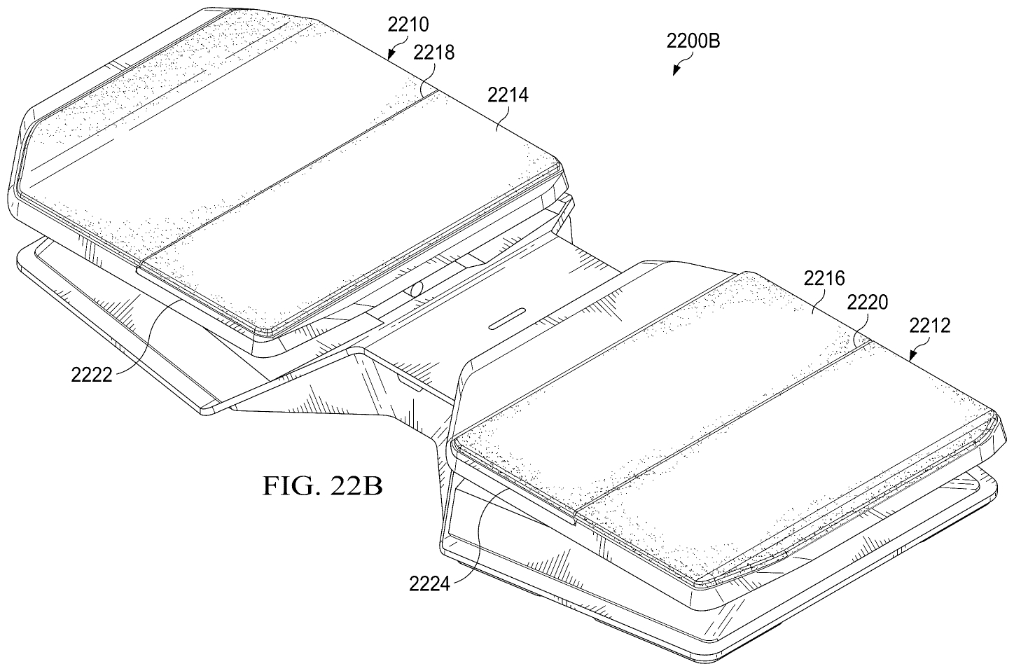

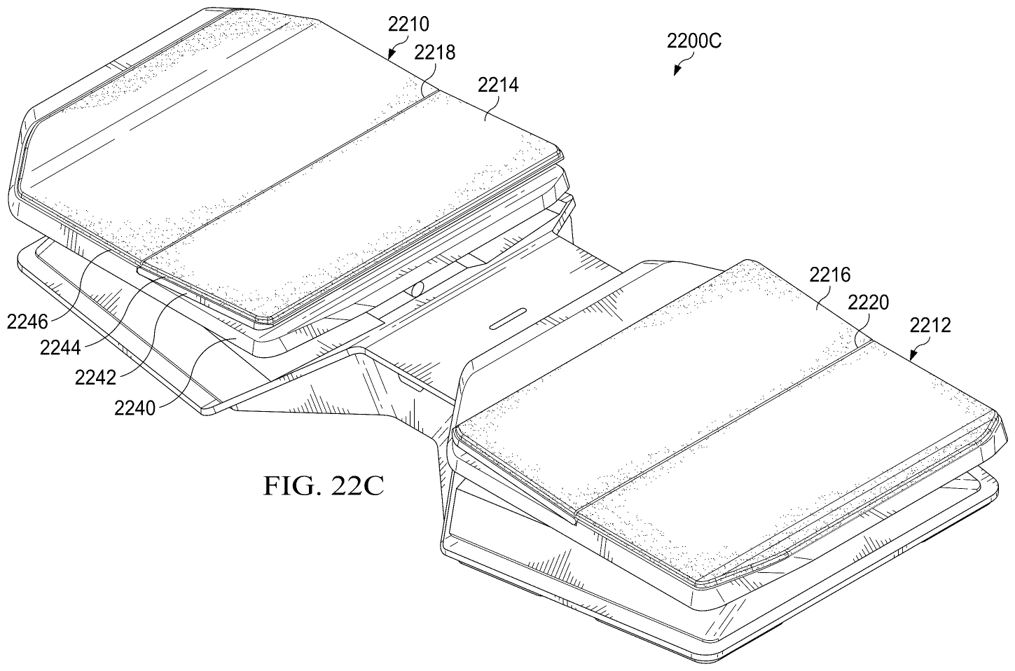

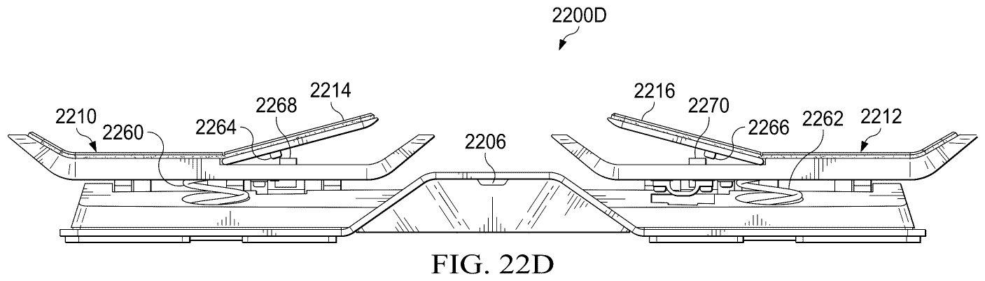

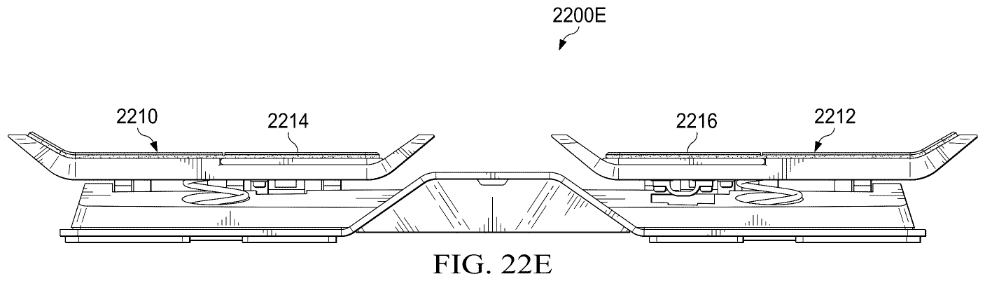

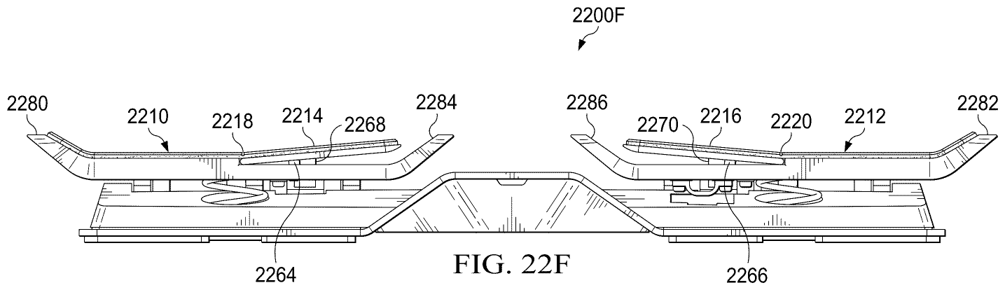

FIG. 22A is a perspective view of a foot-operated input device 2200A in an open position. The open position, which can also be referred to herein as a “neutral position”, is the configuration of the foot-operated input device 2200A in the absence of any user interaction with the foot-operated input device 2200A, i.e., in the absence of any pressing forces by a user.

The foot-operated input device 2200A includes a base 2208 supporting two footpads 2210, 2212. The footpads 2210, 2212 have top surfaces 2222, 2224. Attached to part of the top surfaces 2222, 2224 of the two footpads 2210, 2212 is a layer of textured material. The textured material may provide grip or traction for a user's feet or shoes, and may be a material such as rubber, cloth (like a carpet material), or grooved plastic. The textured material may be connected to the top surfaces 2222, 2224 of the footpads 2210, 2212 through an adhesive such as a glue. In some embodiments, the textured materially may be integrally formed with the top surfaces 2222, 2224 of the footpads 2210, 2212.

Also attached to the top surfaces 2222, 2224 of the two footpads 2210, 2212 are sole flaps 2214, 2216. For the foot-operated input device 2200A, the sole flaps 2214, 2216 are connected to the footpads 2210, 2212 at a hinged interface. For example, the sole flaps 2214, 2216 can be connected to the footpads 2210, 2212 via hinges 2218, 2220. A hinge refers to a joint that allows movement such as tilting. The hinges 2218, 2220 may allow the sole flaps 2214, 2216 to tilt downward toward the top surfaces 2222, 2224 of the footpads 2210, 2212 from a neutral upright position. In some embodiments, the sole flaps 2214, 2216 may be configured to tilt downward enough so that they become flush with the top surfaces 2222, 2224 of the footpads 2210, 2212. Flush means the surfaces are in contact with each other. The hinges 2218, 2220 in the foot-operated input device 2200A can be of types such as butt hinges or spring hinges, and may provide a connection directly between the footpads 2210, 2212 and the sole flaps 2214, 2216 via pins that engage a shared throughbore as in conventional hinges. The hinges 2218, 2220 can also be formed from a score line separating the footpads 2210, 2212 from each of the sole flaps 2214, 2216 to permit tilting movement. The sole flaps 2214, 2216 can be biased on the open or at least partially open configuration by a spring force and/or an elastic force provided by the layer of textured material stretched to span the width of the footpads 2210, 2212 and the sole flaps 2214, 2216.

The foot-operated input device 2200A has a base 2208 that supports the left footpad 2210 with a stanchion 2226. The right footpad 2212 may be supported by the same stanchion 2226 or by a separate stanchion. A stanchion is an upright bar, post, or frame forming a support; and stanchion 2226 is a bar that allows the left footpad 2210 to rotate forward and backward along its axis. As can be seen, the left footpad can tilt forward and backward along the stanchion 2226, and the sole flap 2214 can tilt along a perpindicular axis formed by the hinge 2218.

The base 2208 of the foot-operated input device 2200A has an electronic data slot 2206 at its center. The electronic data slot 2206 may allow the foot-operated input device 2200A to provide control signals to a virtual-reality device or a mechanical device (not shown) based on tilting of the footpads 2210, 2212 (e.g., along the axis of the stanchion 2226), tilting of the sole flaps 2214, 2216 (i.e., along the axes of the hinges 2218, 2220), or some combination thereof. For example, a control signal may be based on the left footpad 2210 being tilted 5 degrees forward, the right footpad being tilted 1 degree backward, the left sole flap 2214 being tilted 2 degrees downward from an initial position, and the right sole flap 2216 being tilted downward 7 degrees from an initial position. Such a control signal may provide four binary inputs, or four analog inputs. For example, the control signal for the angles of the footpads 2210, 2212 may relate to a position of a character in a virtual reality environment and the character's viewing angle, while the sole flaps 2214, 2216 may relate to a position and angle of a character's body, hands, tools, or weapons. The inputs may also relate to other analog inputs, such as a pitch of a flap for a wing of a plane. The inputs may also allow each footpad and sole-flap combination to provide similar inputs to a joystick, thereby providing each foot with its own joystick-like controls. Whether the inputs are taken binary, analog, or a combination of binary and analog, depends on the application (e.g., the type of virtual-reality use case). If the inputs are taken as binary, the foot-operated input device 2200A can provide at least 16 input combinations based on the two footpads 2210, 2212 and two sole flaps 2214, 2216: forward or backward of one footpad, up or down of one sole flap, forward or backward of the other footpad, and up or down of the other sole flap.

The electronic data slot 2206 may be a port compatible with standards such as HDMI, USB, USB-C, micro-USB, mini-USB, displayport, mini dvi, etc. The electronic data slot 2206 may provide data from a virtual reality or mechanical system to the foot-operated input device 2200A, such as for haptic feedback (e.g., vibrations in the base 2208 or the individual footpads 2210 or 2212). Power may be provided to the foot-operated input device 2200A through electronic data slot 2206, such as for powering an internal CPU (such as an arduino), LEDs, or one or more actuators (e.g., electric motors or other mechanisms) for stabilizing the footpads or providing haptic feedback.

Movement of the footpads or the sole flaps may be converted into electronic input through sensors. There may be at least one sensor associated with the left footpad 2210, at least one sensor associated with the right footpad 2212, at least one sensor associated with the left sole flap 2214, and at least one sensor associated with the right sole flap 2216. The sensors can be, for example, resistive sensors, conductive sensors, piezoelectric sensors, or other types of sensors, such as a rotary encoder that converts angular position or motion into analog or digital output signals.

FIG. 22B is a perspective view of a foot-operated input device 2200B in a closed position. As can be seen, the foot-operated input device 2200B has the left sole flap 2214 flush to the top surface 2222 of the left footpad, based on a tilting about an axis formed by the left hinge 2218 of the sole flap 2214 relative to the left footpad. The right sole flap 2216 is similarly closed such that it is flush with the top surface 2224 of the right footpad, based on a tilting of the right sole flap 2216 about the right hinge 2220. The sole flaps 2214, 2216 may open or close independently (i.e., one may be open while the other is closed). The sole flaps 2214, 2216 may be closed, for example, based on a user's feet resting on the footpads 2210, 2212 to provide a pressing force that causes each of the sole flaps 2214, 2216 to remain flush with the top surfaces 2222, 2224 of the respective footpads 2210, 2212.

FIG. 22C is a perspective view of a foot-operated input device 2200C in a partially open position. This configuration may occur, for example, based on a user applying a pressure between a force associated with the closed position and the open position described for FIGS. 22A and 22B. The pressure can be provided by a user lifting the user's feet from the top surfaces 2222, 2224 of the footpads 2210, 2212 just enough to cause the sole flaps 2214, 2216 to achieve the partially open configuration, or by the lateral rolling of the user's foot to cause the sole flaps 2214, 2216 to raise just enough to achieve the partially open configuration. This configuration may also represent an alternative starting position of the sole flaps 2214, 2216 relative to the footpads 2210, 2212. Indicated in FIG. 22C are the footpads 2210, 2212, the sole flaps 2214, 2216, and the hinges 2218, 2220.

Also illustrated for the left footpad 2210 are separate identification of the footpad base portion 2240 and the sole flap base portion 2242, each of which may be plastic, metal, or other suitable material for providing rigidity. Also illustrated for the left footpad 2210 are separate identification of the layer of textured material attached to the top of the footpad 2246 and the layer of textured material attached to the top of the sole flap 2244, each of which may be attached through adhesive, may be the same or different materials, and may comprise a rubber, cloth, or other textured material for providing grip to a user's feet (e.g., to a user's shoes). Having a layer of textured material may help prevent a user's feet from sliding across the top surfaces of the foot-operated input device 2200C. Having a uniform single-piece textured material covering a part of a sole flap and a part of a top surface of a footpad (e.g., by covering the top of a hinge) may have advantages including for user experience and aesthetics.

FIG. 22D is a front view of a foot-operated input device 2200D in an open position. The foot-operated input device 2200D has sole flaps 2214, 2216, and an electronic data slot 2206. It also has footpad front springs 2260, 2262, which may accompany footpad back springs (not shown) to bring the footpads to a neutral position. The foot-operated input device 2200D has sole flap springs 2268, 2270, and sole flap stoppers 2266, 2268. The sole flap springs 2268, 2270 may each be made of a metal, plastic, rubber or other material that can provide spring-like characteristics. For example, the sole flap springs may be TPU springs that comprise TPU (plastic) formed in a ring shape to allow deformation such that the TPU can return to an original position after being compressed, to help bias the sole flaps 2214, 2216 back to the neutral position. The sole flap springs 2268, 2270 and sole flap stoppers 2266, 2268 may fit into grooves in the footpads or the sole flaps. The sole flap springs 2268, 2270 may be attached to the footpad and come into contact with the sole flaps, and may force the sole flaps 2214, 2216 upward. The sole flap stoppers 2266, 2268 may be attached to the sole flaps and come into contact with the footpads, and may prevent the sole flap springs 2268, 2270 from being subject to excess force or displacement. The sole flap stoppers 2266, 2268 may prevent the sole flaps 2214, 2216 from tilting downward more than parallel relative to the top surface of the footpad. In addition, or in the alternative, the sole flap stoppers 2266, 2268 may engage a switch or button that provides the analog or digital output that dictates a whether a sole flap 2214, 2216 was pressed and/or a magnitude of the pressing force. The springs may also be conical, torsion, compression, or other types of springs that can help the footpads and sole flaps to efficiently return to a neutral or starting position. When a spring is compressed—whether the spring is spiral, ring, or of another shape—its length can be said to decrease. In some embodiments, the compression of the springs may be measured and used to determine whether the sole flaps 2214, 2216 actuated for generating an analog/digital and/or binary/incremental signal.

FIG. 22E is a front view of a foot-operated input device 2200E in a closed position. The foot-operated input device 2200E has footpads 2210, 2212 connected to sole flaps 2214, 2216. As can be seen, the sole flaps 2214, 2216 are flush with the top surfaces of the footpads 2210, 2212.

FIG. 22F is a front view of a foot-operated input device 2200F in a half-open position. This configuration may occur, for example, based on a user applying a pressure between a force associated with the closed position and the open position described for FIGS. 22D and 22E. This configuration may also represent an alternative starting position of the sole flaps 2214, 2216 relative to the footpads 2210, 2212. As can be seen in FIG. 22F, the sole flap springs 2268, 2270 and sole flap stoppers 2266, 2268 are each in contact with both a sole flap and a top surface of a footpad.

Also identified in FIG. 22F are wings 2280, 2282, 2284, and 2286 of the footpads 2210, 2212. The wings are upward-angled portions of the footpads that help prevent users' feet from sliding off the sides of the footpads. In some embodiments, the sole flaps 2214, 2216 may also have wings on their extended ends.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes that come within the meaning and range of equivalency of the claims are therefore intended to be embraced therein. Further, the recitation of method steps does not denote a particular sequence for execution of the steps. Such method steps may therefore be performed in a sequence other than recited unless the particular claim expressly states otherwise.

### Additional Description

The following paragraphs are offered as further description of the various embodiments of the disclosed invention.

In a first embodiment, novel aspects of the present disclosure describe a virtual reality locomotion apparatus comprising: a stanchion for supporting two footpads, wherein the two footpads rotate on an axis passing through the stanchion; a plurality of sensors that detect the rotation of each footpad; and a controller transmitting signals from the plurality of sensors representing the rotation of each footpad to a virtual reality system.

In another aspect of the first embodiment, novel aspects of the present disclosure describe a virtual reality locomotion apparatus comprising: a stanchion for supporting two footpads, wherein the two footpads rotate on an axis passing through the stanchion; a plurality of sensors that detect the rotation of each footpad; and a controller transmitting signals from the plurality of sensors representing the rotation of each footpad to a virtual reality system, and one or more limitations selected from the following list:
wherein the system further comprises a second stanchion for supporting the two footpads, wherein the axis also passes through the second stanchion;
wherein the system further comprises an illusory wheel attached to a first end of the stanchion;
wherein the system further comprises a plurality of environmental simulators;
wherein at least one of the environmental simulators comprises vibrators;
wherein at least one of the environmental simulators comprises fans;
wherein at least one of the environmental simulators comprises speakers;
wherein the system further comprises a central rotatable post wherein, the plurality of sensors detect rotation of the central rotatable post and the controller transmits signals representing the rotation of the central rotatable post to the virtual reality system;
wherein the controller receives output signals from the virtual reality system to actuate the environmental simulators;
wherein the system further comprises a platform for the stanchion, wherein the rotation of the footpads actuates rotation of the stanchion on a platform axis perpendicular to the platform.

In a second embodiment, novel aspects of the present disclosure describe a method for virtual reality locomotion, comprising: stabilizing footpads of a virtual reality locomotion apparatus using motors controlled by a locomotion controller; detecting the rotation of the footpads on an axis passing through the footpads via sensors of the footpads that detect rotation of the footpads; and transmitting a digital representation of the rotation of the footpads to a virtual reality system.

In another aspect of the second embodiment, novel aspects of the present disclosure describe a method for virtual reality locomotion, comprising: stabilizing footpads of a virtual reality locomotion apparatus using motors controlled by a locomotion controller; detecting the rotation of the footpads on an axis passing through the footpads via sensors of the footpads that detect rotation of the footpads; and transmitting a digital representation of the rotation of the footpads to a virtual reality system; and one or more limitations selected from the following list:
wherein the method further comprises calibrating signals from the sensors of the footpads;
wherein the method further comprises detecting and analyzing weight and balance distribution of a user, when the user stands on the footpads, using the sensors;
wherein the method further comprises actuating a plurality of environmental simulators upon receiving instructions from the virtual reality system;
wherein at least one of the environmental simulators comprises vibrators;
wherein at least one of the environmental simulators comprises fans;
wherein at least one of the environmental simulators comprises speakers;
wherein the virtual locomotion apparatus comprises a stanchion for supporting two footpads;
wherein the method further comprises rotating the virtual locomotion apparatus on a stationary platform in response to the rotation of the footpads;
wherein the method further comprises transmitting a digital representation of rotation of a central locomotion post to the virtual reality system.

In some embodiments, novel aspects of the present disclosure include a foot-operated input device comprising: a first footpad that is movable by tilting along an axis; a second footpad that is movable by tilting along the axis, wherein the first footpad and the second footpad are independently tiltable in a same direction or in an opposite direction along the axis; a first sole flap extending from a top surface of the first footpad and configured to tilt relative to that surface; a second sole flap extending from a top surface of the second footpad and configured to tilt relative to that surface; a set of sensors configured to detect a position of the first footpad, a position of the second footpad, a position of the first sole flap, and a position of the second sole flap; and a processor configured to generate control signals from the positions detected by the set of sensors.

In some embodiments, novel aspects of the present disclosure include a system comprising: a display system configured to depict an environment; and a foot-operated input device communicatively coupled to the display system and configured to provide control signals to control movement in the environment, the foot-operated input device including: a first footpad that is movable by tilting along an axis; a second footpad that is movable by tilting along the axis, wherein the first footpad and the second footpad are independently tiltable in a same direction or in an opposite direction along the axis; a first sole flap extending from a top surface of the first footpad and configured to tilt relative to that surface; a second sole flap extending from a top surface of the second footpad and configured to tilt relative to that surface; a set of sensors configured to detect a position of the first footpad, a position of the second footpad, a position of the first sole flap, and a position of the second sole flap; and a processor configured to generate the control signals, the generation being based on the positions detected by the set of sensors.

In some embodiments, novel aspects of the present disclosure include a method of controlling movement comprising: detecting a position of a first footpad that is movable by tilting along an axis; detecting a position of a second footpad that is movable by tilting along the axis, wherein the first footpad and the second footpad are independently tiltable in a same direction or in an opposite direction along the axis; detecting a position of a first sole flap, the first sole flap extending from a top surface of the first footpad and configured to tilt relative to that surface; detecting a position of a second sole flap, the second sole flap extending from a top surface of the second footpad and configured to tilt relative to that surface; and generating control signals from the position of the first footpad, the position of the second footpad, the position of the first sole flap, and the position of the second sole flap.

In some embodiments, novel aspects of the present disclosure include at least one of the following:
(1) a first hinge to secure the first sole flap to the first footpad, and a second hinge to secure the second sole flap to the second footpad.
(2) the first sole flap is configured to become substantially flush with the surface of the first footpad in response to force on the first sole flap from a user, and the second sole flap is configured to become substantially flush with the surface of the second footpad in response to force on the second sole flap from the user.
(3) a first spring operatively connected to the first footpad, the first spring changing in length when force is applied to a front of the first footpad or to a back of the first footpad; a second spring operatively connected to the second footpad, the second spring changing in length when force is applied to a front of the second footpad or to a back of the second footpad; a third spring operatively connected to the first sole flap, the third spring changing in length when force is applied to a side of the first footpad; and a fourth spring operatively connected to the second sole flap, the third spring changing in length when force is applied to a side of the second footpad.
(4) the first sole flap is angled upward in a direction from the first footpad to the second footpad; the second sole flap is angled upward in a direction from the second footpad to the first footpad; when a user applies force to the first sole flap, a surface of the sole flap becomes more parallel to the surface of the first footpad; and when the user applies force to the second sole flap, a surface of the sole flap becomes more parallel to the surface of the second footpad.
(5) generating control signals comprises determining a change in position of one of the first footpad, the second footpad, the first sole flap, or the second sole flap.

1. A foot-operated input device comprising:
a first footpad that is movable by tilting along an axis;
a second footpad that is movable by tilting along the axis, wherein the first footpad and the second footpad are independently tiltable in a same direction or in an opposite direction along the axis;
a first sole flap extending from a top surface of the first footpad and configured to tilt relative to that surface;
a second sole flap extending from a top surface of the second footpad and configured to tilt relative to that surface;
a set of sensors configured to detect a position of the first footpad, a position of the second footpad, a position of the first sole flap, and a position of the second sole flap; and
a processor configured to generate control signals from the positions detected by the set of sensors.

2. The foot-operated input device of claim 1, wherein the control signals are customizable via a configurator interface.

3. The foot-operated input device of claim 1, further comprising:
one or more stanchions configured to support the first footpad and the second footpad on the base;
a first hinge to secure the first sole flap to the first footpad; and
a second hinge to secure the second sole flap to the second footpad.

4. The foot-operated input device of claim 1, wherein:
the first sole flap is configured to become substantially flush with the top surface of the first footpad in response to force on the first sole flap from a user; and
the second sole flap is configured to become substantially flush with the top surface of the second footpad in response to force on the second sole flap from the user.

5. The foot-operated input device of claim 1, further comprising:
a first spring operatively connected to the first footpad, the first spring changing in length when force is applied to a front of the first footpad or to a back of the first footpad;
a second spring operatively connected to the second footpad, the second spring changing in length when force is applied to a front of the second footpad or to a back of the second footpad;
a third spring operatively connected to the first sole flap, the third spring changing in length when force is applied to a side of the first footpad; and
a fourth spring operatively connected to the second sole flap, the third spring changing in length when force is applied to a side of the second footpad.

6. The foot-operated input device of claim 1, further comprising:
a communications interface configured to transmit the control signals to one of a virtual reality system or a mechanical device.

7. The foot-operated input device of claim 1, wherein:
the first sole flap is angled upward in a direction from the first footpad to the second footpad;
the second sole flap is angled upward in a direction from the second footpad to the first footpad;
when a user applies force to the first sole flap, a surface of the sole flap becomes more parallel to the top surface of the first footpad; and
when the user applies force to the second sole flap, a surface of the sole flap becomes more parallel to the top surface of the second footpad.

8. A system comprising:
a display system configured to depict an environment; and
a foot-operated input device communicatively coupled to the display system and configured to provide control signals to control movement in the environment, the foot-operated input device including:
a first footpad that is movable by tilting along an axis;
a second footpad that is movable by tilting along the axis, wherein the first footpad and the second footpad are independently tiltable in a same direction or in an opposite direction along the axis;
a first sole flap extending from a top surface of the first footpad and configured to tilt relative to that surface;
a second sole flap extending from a top surface of the second footpad and configured to tilt relative to that surface;
a set of sensors configured to detect a position of the first footpad, a position of the second footpad, a position of the first sole flap, and a position of the second sole flap; and
a processor configured to generate the control signals, the generation being based on the positions detected by the set of sensors.

9. The system of claim 8, wherein the display system is configured to depict a configurator interface for customizing the control signals.

10. The system of claim 8, further comprising:
one or more stanchions configured to support the first footpad and the second footpad on the base;
a first hinge to secure the first sole flap to the first footpad; and
a second hinge to secure the second sole flap to the second footpad.

11. The system of claim 10, wherein:
the first sole flap is configured to become substantially flush with the surface of the first footpad in response to force on the first sole flap from a user; and
the second sole flap is configured to become substantially flush with the surface of the second footpad in response to force on the second sole flap from the user.

12. The system of claim 8, further comprising:
a first spring operatively connected to the first footpad, the first spring changing in length when force is applied to a front of the first footpad or to a back of the first footpad;
a second spring operatively connected to the second footpad, the second spring changing in length when force is applied to a front of the second footpad or to a back of the second footpad;
a third spring operatively connected to the first sole flap, the third spring changing in length when force is applied to a side of the first footpad; and
a fourth spring operatively connected to the second sole flap, the third spring changing in length when force is applied to a side of the second footpad.

13. The system of claim 8, wherein:
the first sole flap is angled upward in a direction from the first footpad to the second footpad;
the second sole flap is angled upward in a direction from the second footpad to the first footpad;
when a user applies force to the first sole flap, a surface of the sole flap becomes more parallel to the surface of the first footpad; and
when the user applies force to the second sole flap, a surface of the sole flap becomes more parallel to the surface of the second footpad.

14. A method of controlling movement comprising:
detecting a position of a first footpad that is movable by tilting along an axis;
detecting a position of a second footpad that is movable by tilting along the axis, wherein the first footpad and the second footpad are independently tiltable in a same direction or in an opposite direction along the axis;
detecting a position of a first sole flap, the first sole flap extending from a top surface of the first footpad and configured to tilt relative to that surface;
detecting a position of a second sole flap, the second sole flap extending from a top surface of the second footpad and configured to tilt relative to that surface; and
generating control signals from the position of the first footpad, the position of the second footpad, the position of the first sole flap, and the position of the second sole flap.

15. The method of claim 14, wherein the control signals are customizable via a configurator interface.

16. The method of claim 14, wherein generating control signals comprises determining a change in position of one of the first footpad, the second footpad, the first sole flap, or the second sole flap.

17. The method of claim 14, wherein:
the first footpad and the second footpad are supported by one or more stanchions;
the first sole flap is secured to the first footpad with a first hinge; and
the second sole flap is secured to the second footpad with a second hinge.

18. The method of claim 14, further comprising:
transmitting the control signals to one of a virtual reality environment or a mechanical device via a communications interface, where the controlling the movement relates to movement in a virtual reality environment or of a mechanical device.

19. The method of claim 14, wherein:
the first sole flap is configured to become substantially flush with the surface of the first footpad in response to force on the first sole flap from a user; and
the second sole flap is configured to become substantially flush with the surface of the second footpad in response to force on the second sole flap from the user.

20. The method of claim 14, wherein:
the first sole flap is angled upward in a direction from the first footpad to the second footpad;
the second sole flap is angled upward in a direction from the second footpad to the first footpad;
when a user applies force to the first sole flap, a surface of the sole flap becomes more parallel to the surface of the first footpad; and
when the user applies force to the second sole flap, a surface of the sole flap becomes more parallel to the surface of the second footpad.
